SEQUENCE LISTING (2 sequences)

SEQ ID NO: 1 - DNA, 61 bp, Unknown
  Synthetic polynucleotide - Figure 6
  variation (31)..(31): T or A
gattttattcttacaacacaaaatcaaatcvcacacacacacacacacacacacacactcg

SEQ ID NO: 2 - DNA, 36 bp, Unknown
  Synthetic polynucleotide - Figures 11 and 13A
  variation (31)..(31): C or G
ggcgcgagaacggaggtagctttttaaaaavgaaga

(19) United States
(12) Patent Application Publication
(10) Pub. No.: US 2017/0270212 A1
(43) Pub. Date: Sep. 21, 2017

(54) GENOMIC, METABOLOMIC, AND MICROBIOMIC SEARCH ENGINE

(71) Applicant: Human Longevity, Inc., San Diego, CA (US)

(72) Inventors: Victor Lavrenko, Mountain View, CA (US); Amalio Telenti, La Jolla, CA (US); Franz Josef Och, Mountain View, CA (US)

(21) Appl. No.: 15/465,454

(22) Filed: Mar. 21, 2017

Related U.S. Application Data
(60) Provisional application No. 62/311,333, filed on Mar. 21, 2016.
(60) Provisional application No. 62/311,337, filed on Mar. 21, 2016.

(51) Int. Cl. G06F 17/30; G06N 99/00

(52) U.S. Cl. CPC G06F 17/30867; G06F 17/3053; G06N 99/005; G06F 19/18

(57) ABSTRACT

Disclosed are systems, media, and methods for providing a genomic search engine application comprising: a plurality of indices, recorded in the computer storage, the indices comprising tokenized genomic data; a software module providing an indexing pipeline, the indexing pipeline ingesting genomic data and annotation associated with the genomic data, tokenizing the data while preserving gene names and gene variant names, and updating the indices with the tokenized data; and a software module presenting a user interface allowing a user to enter a user query; a software module providing a query engine, the query engine accepting the user query, selecting one or more relevant indices, and applying a ranking formula to the selected indices to return ranked results.

### CROSS-REFERENCE TO RELATED APPLICATIONS

This application claims priority to U.S. Provisional App. Ser. No. 62/311,333 filed on Mar. 21, 2016; and U.S. Provisional App. Ser. No. 62/311,337 filed on Mar. 21, 2016 all of which are incorporated by reference herein in their entirety.

### BACKGROUND OF THE INVENTION

Since the first human genome was sequenced in 2001, the use of genomic data in research has increased greatly. In that time, the price of a whole-genome sequence for an individual has fallen to levels within the reach of many individuals. With this increase of genetic information and diversification of users, the problem of how to organize, access and mine this data has come to the forefront of the personalized medicine revolution.

### SUMMARY OF THE INVENTION

Current bioinformatic techniques, software and user interfaces suffer from several fatal flaws that prevent personal access to genomic information (indeed often times it prevents access to non-specialist medical practitioners). One problem is the sheer amount of information to search; a single genome can encompass several gigabytes worth of information. Another problem is the limited information on and poor validation of genomic sequence variants, especially low frequency alleles. The dispersed nature of these variants and information on them leads to poor performance of ranking scoring and indexing algorithms. Current user interfaces require a high degree of sophistication by users, are not very user friendly, are slow, and limited in their ability to handle multiple or layered queries. Current databases of genomic data tend to be highly underpowered and thus possess little opportunity for data mining. Further, no current user interfaces are geared towards allowing a user or their healthcare professional the ability to interact with their genomic and health data in an unrestrained and customizable way. These problems are encountered by individuals, their healthcare providers, and disease researchers. Due to these problems current interfaces, databases and systems for querying genomic data have reduced utility and are severely limited by restraints imposed by the computer systems that operate on standard search algorithms and logics. They also are limited in that in general they require a high level of sophistication with regard to bioinformatics. Often genetic disease associations are mined or discovered by specialists using sophisticated analytical and statistical methods, which are not accessible to non-specialist medical professionals (such as an internist, general practitioner pediatrician, etc.). The methods of this disclosure provide for improvements in genomic querying and analysis due to increased user friendliness, search speed and power (i.e., the amount of relevant information retrieved by a single number or limited number of searches). These methods allow non-specialist medical professionals and individuals to manage disease-risk, discover actionable variants, and develop more accurate disease prognoses.

The platforms, systems, media, and methods described herein, in some embodiments, address all of these current and long-standing problems with genomic data. For example, disclosed herein are platforms, systems, media, and methods that are user-friendly, fast, and are significantly improved with regard to the quality and completeness of genomic data. Some of the specific improvements and difference compared to current methods are listed below:

The platforms, systems, media, and methods described herein, in some embodiments, rank results as opposed to filtering results. In such embodiments, the goal is to provide access to all knowledge, which has various degrees of reliability, rather than to eliminate information from consideration. A standard approach is to curate that knowledge to filter wrong information and only keep correct information. The filtering approach is not appropriate for genomic (or more broadly scientific) knowledge, as there is a vast grey area of knowledge. Instead, a better method is to provide access to all information, but rank it appropriately so that the first search results are more likely to be useful.

The platforms, systems, media, and methods described herein, in some embodiments, increase interactivity (as opposed to batch computation). In such embodiments, the goal is make all interactions with the system truly interactive, providing an answer in less than a second. In certain embodiments, the methods described herein can provide an answer to a query in less than 900, 800, 700, 600, 500, 400, 300, 200, 100 milliseconds or less, including increments therein. The query can provide, among other feedback, ranked results relating to disease susceptibility, ancestry, potential pathogenic genomic variants, on the fly genome wide-association studies (GWAS), and genotype-phenotype associations.

The platforms, systems, media, and methods described herein, in some embodiments, provide a universal search interface (as opposed to many different entry points). In such embodiments, all knowledge, whether it is about people, variants, genes, pathways, phenotype data, etc., is accessible through the same simple search interface.

The platforms, systems, media, and methods described herein, in some embodiments, use information obtained from user queries to enhance knowledge that is accessible through the system. When a user enters a query, for example, a search term or a data file (e.g., a genomic sequence data file or VCF file) that information is incorporated into the database and is used to further enhance the amount of knowledge that is contained in the system. In some instances an individual can further ad demographic data, family history, physiological measurements, or clinical results.

The platforms, systems, media, and methods described herein, in some embodiments, incorporate feedback mechanisms. In such embodiments, the system comprises one or more mechanisms to collect feedback from users ranging from tracking click-through information to explicit mechanisms to mark search results as good/bad.

The platforms, systems, media, and methods described herein, in some embodiments, incorporate augmented intelligence. For example, the system strives to make a human as efficient as possible in answering an information need. To achieve this goal, in further embodiments, the system is designed to help the user ask the right (follow-up) questions to the system.

In one aspect, disclosed herein are computer-implemented systems comprising: a computer storage, a digital processing device comprising: at least one processor, an operating system configured to perform executable instructions, a memory, and a computer program including instructions executable by the digital processing device to create a genomic search engine application comprising: a plurality of indices, recorded in the computer storage, the indices comprising tokenized genomic data; a software module providing an indexing pipeline, the indexing pipeline ingesting genomic data and annotation associated with the genomic data, tokenizing the data while preserving gene names and gene variant names, and updating the indices with the tokenized data; a software module presenting a user interface allowing a user to enter a user query; and a software module providing a query engine, the query engine accepting the user query, selecting one or more relevant indices, and applying a ranking formula to the selected indices to return ranked results. In some embodiments, the application further comprises a software module presenting a user interface allowing the user to provide user feedback on content and ranking of the results. In further embodiments, the application comprises a software module providing a relevance-learning engine, the relevance-learning engine accepting the user feedback and tuning the ranking formula based on the feedback. In some embodiments, the genomic data comprises metadata. In further embodiments, the metadata comprises any of an individual identifier, physiological data, clinical data, family medical history data, metabolome data, and microbiome data. In some embodiments, the genomic data comprises whole genome sequence data or whole exome sequence data. In some embodiments, the application further comprises a software module presenting a user interface allowing the user to upload genomic data into the indexing pipeline. In further embodiments, the software module presenting a user interface allowing the user to upload genomic data issues an individual identifier to the user upon completion of the upload. In some embodiments, the user query comprises a genomic sequence file, a gene, a gene variant or mutation, an individual identifier, a drug, a phenotype, or a combination thereof. In further embodiments, the interface allowing a user to enter a user query is a universal interface accepting entry of any of: a genomic sequence file, a gene, a gene variant or mutation, an individual identifier, a drug, a phenotype, or a combination thereof. In some embodiments, the user query comprises a gene name and the ranked results comprise variants associated with the gene. In some embodiments, the user query comprises an individual identifier and the ranked results comprise gene variants in the genome of the individual. In some embodiments, the user query comprises an individual identifier and a phenotype and the ranked results comprise gene variants in the genome of the individual associated with the phenotype. In some embodiments, the user query comprises a gene variant and the ranked results comprise patient identifiers for patients who have the variant in their genome. In some embodiments, the user query comprises a phenotype and the ranked results comprise gene variants that are associated with the phenotype. In some embodiments, the query comprises natural language terms and one or more special operators. In some embodiments, the user query comprises a first patient identifier and at least a second patient identifier, wherein each of the individual identifiers are separated by a operator and the ranked results comprise gene variants that are present in the genome of the first patient and not in the genome of the second patient. In further embodiments, the user query comprises a first patient identifier that is for a child, a second patient identifier that is for the mother of the child, and a third patient identifier that is for the father of the child, and the ranked results comprise gene variants that are present in the genome of the child but not in the genomes of either the mother or the father. In some embodiments, the genomic data comprises a population of genomic sequences, which population of genomic sequences is used to calculate a relative frequency for variants that are present in members of the population of genomic sequences. In further embodiments, the population of genomic sequences comprises at least 10,000 genomic sequences. In still further embodiments, the population of genomic sequences comprises at least 100,000 genomic sequences. In some embodiments, the ranking formula comprises using the relative frequency to rank results obtained from a user query. In some embodiments, the query comprises a photo of a person's face. In some embodiments, the results are ranked without filtering. In some embodiments, the results comprise a gene, a gene variant, a protein, a pathway, a phenotype, a person, an article, an electronic medical record, an interactive tool, or a combination thereof. In further embodiments, the interactive tool is a genome browser or a gene browser. In some embodiments, the feedback on result content comprises annotation. In some embodiments, the feedback on result ranking comprises a suggestion to remove a result. In some embodiments, the feedback on result ranking comprises a suggestion to promote a result. In some embodiments, the relevance-learning engine augments the user feedback with information from external sources. In some embodiments, the user query itself comprises annotation or is otherwise incorporated into the database. In some embodiments, access by the user requires two-factor authentication. In some embodiments, the user query comprises the user's voice. In some embodiments, the plurality of indices are reduced in number by pre-joining two or more of the plurality of indices. In some embodiments, the method further comprises pre-joining two or more of the plurality of indices.

In another aspect, disclosed herein are non-transitory computer-readable storage media encoded with a computer program including instructions executable by a processor to create a genomic search engine application comprising: a plurality of indices, recorded in the computer storage, the indices comprising tokenized genomic data; a software module providing an indexing pipeline, the indexing pipeline ingesting genomic data and annotation associated with the genomic data, tokenizing the data while preserving gene names and gene variant names, and updating the indices with the tokenized data; and a software module presenting a user interface allowing a user to enter a user query; a software module providing a query engine, the query engine accepting the user query, selecting one or more relevant indices, and applying a ranking formula to the selected indices to return ranked results. In some embodiments, the application further comprises a software module presenting a user interface allowing the user to provide user feedback on content and ranking of the results. In further embodiments, the application comprises a software module providing a relevance-learning engine, the relevance-learning engine accepting the user feedback and tuning the ranking formula based on the feedback. In some embodiments, the genomic data comprises metadata. In further embodiments, the metadata comprises any of an individual identifier, physiological data, clinical data, family medical history data, metabolome data, and microbiome data. In some embodiments, the genomic data comprises whole genome sequence data or whole exome sequence data. In some embodiments, the application further comprises a software module presenting a user interface allowing the user to upload genomic data into the indexing pipeline. In further embodiments, the software module presenting a user interface allowing the user to upload genomic data issues an individual identifier to the user upon completion of the upload. In some embodiments, the user query comprises a genomic sequence file, a gene, a gene variant or mutation, an individual identifier, a drug, a phenotype, or a combination thereof. In further embodiments, the interface allowing a user to enter a user query is a universal interface accepting entry of any of: a genomic sequence file, a gene, a gene variant or mutation, an individual identifier, a drug, a phenotype, or a combination thereof. In some embodiments, the user query comprises a gene name and the ranked results comprise variants associated with the gene. In some embodiments, the user query comprises an individual identifier and the ranked results comprise gene variants in the genome of the individual. In some embodiments, the user query comprises an individual identifier and a phenotype and the ranked results comprise gene variants in the genome of the individual associated with the phenotype. In some embodiments, the user query comprises a gene variant and the ranked results comprise patient identifiers for patients who have the variant in their genome. In some embodiments, the user query comprises a phenotype and the ranked results comprise gene variants that are associated with the phenotype. In some embodiments, the query comprises natural language terms and one or more special operators. In some embodiments, the user query comprises a first patient identifier and at least a second patient identifier, wherein each of the individual identifiers are separated by a operator and the ranked results comprise gene variants that are present in the genome of the first patient and not in the genome of the second patient. In further embodiments, the user query comprises a first patient identifier that is for a child, a second patient identifier that is for the mother of the child, and a third patient identifier that is for the father of the child, and the ranked results comprise gene variants that are present in the genome of the child but not in the genomes of either the mother or the father. In some embodiments, the genomic data comprises a population of genomic sequences, which population of genomic sequences is used to calculate a relative frequency for variants that are present in members of the population of genomic sequences. In further embodiments, the population of genomic sequences comprises at least 10,000 genomic sequences. In still further embodiments, the population of genomic sequences comprises at least 100,000 genomic sequences. In some embodiments, the ranking formula comprises using the relative frequency to rank results obtained from a user query. In some embodiments, the query comprises a photo of a person's face. In some embodiments, the results are ranked without filtering. In some embodiments, the results comprise a gene, a gene variant, a protein, a pathway, a phenotype, a person, an article, an electronic medical record, an interactive tool, or a combination thereof. In further embodiments, the interactive tool is a genome browser or a gene browser. In some embodiments, the feedback on result content comprises annotation. In some embodiments, the feedback on result ranking comprises a suggestion to remove a result. In some embodiments, the feedback on result ranking comprises a suggestion to promote a result. In some embodiments, the relevance-learning engine augments the user feedback with information from external sources. In some embodiments, access by the user requires two-factor authentication. In some embodiments, the user query comprises the user's voice. In some embodiments, the plurality of indices are reduced in number by pre joining two or more of the plurality of indices.

In another aspect, disclosed herein are computer-implemented methods of providing a genomic search engine comprising: storing a plurality of indices in a computer storage, the indices comprising tokenized genomic data; providing an indexing pipeline, the indexing pipeline ingesting genomic data and annotation associated with the genomic data, tokenizing the data while preserving gene names and gene variant names, and updating the indices with the tokenized data; presenting a user interface allowing a user to enter a user query; and providing a query engine, the query engine accepting the user query, selecting one or more relevant indices, and applying a ranking formula to the selected indices to return ranked results. In some embodiments, the method further comprises presenting a user interface allowing the user to provide user feedback on content and ranking of the results. In further embodiments, the method further comprises providing a relevance-learning engine, the relevance-learning engine accepting the user feedback and tuning the ranking formula based on the feedback. In some embodiments, the genomic data comprises metadata. In further embodiments, the metadata comprises any of an individual identifier, physiological data, clinical data, family medical history data, metabolome data, and microbiome data. In some embodiments, the genomic data comprises whole genome sequence data or whole exome sequence data. In some embodiments, the method further comprises presenting a user interface allowing the user to upload genomic data into the indexing pipeline. In further embodiments, the software module presenting a user interface allowing the user to upload genomic data issues an individual identifier to the user upon completion of the upload. In some embodiments, the user query comprises a genomic sequence file, a gene, a gene variant or mutation, an individual identifier, a drug, a phenotype, or a combination thereof. In further embodiments, the interface allowing a user to enter a user query is a universal interface accepting entry of any of: a genomic sequence file, a gene, a gene variant or mutation, an individual identifier, a drug, a phenotype, or a combination thereof. In some embodiments, the user query comprises a gene name and the ranked results comprise variants associated with the gene. In some embodiments, the user query comprises an individual identifier and the ranked results comprise gene variants in the genome of the individual. In some embodiments, the user query comprises an individual identifier and a phenotype and the ranked results comprise gene variants in the genome of the individual associated with the phenotype. In some embodiments, the user query comprises a gene variant and the ranked results comprise patient identifiers for patients who have the variant in their genome. In some embodiments, the user query comprises a phenotype and the ranked results comprise gene variants that are associated with the phenotype. In some embodiments, the query comprises natural language terms and one or more special operators. In some embodiments, the user query comprises a first patient identifier and at least a second patient identifier, wherein each of the individual identifiers are separated by a operator and the ranked results comprise gene variants that are present in the genome of the first patient and not in the genome of the second patient. In further embodiments, the user query comprises a first patient identifier that is for a child, a second patient identifier that is for the mother of the child, and a third patient identifier that is for the father of the child, and the ranked results comprise gene variants that are present in the genome of the child but not in the genomes of either the mother or the father. In some embodiments, the genomic data comprises a population of genomic sequences, which population of genomic sequences is used to calculate a relative frequency for variants that are present in members of the population of genomic sequences. In further embodiments, the population of genomic sequences comprises at least 10,000 genomic sequences. In still further embodiments, the population of genomic sequences comprises at least 100,000 genomic sequences. In some embodiments, the ranking formula comprises using the relative frequency to rank results obtained from a user query. In some embodiments, the query comprises a photo of a person's face. In some embodiments, the results are ranked without filtering. In some embodiments, the results comprise a gene, a gene variant, a protein, a pathway, a phenotype, a person, an article, an electronic medical record, an interactive tool, or a combination thereof. In further embodiments, the interactive tool is a genome browser or a gene browser. In some embodiments, the feedback on result content comprises annotation. In some embodiments, the feedback on result ranking comprises a suggestion to remove a result. In some embodiments, the feedback on result ranking comprises a suggestion to promote a result. In some embodiments, the relevance-learning engine augments the user feedback with information from external sources. In some embodiments, access by the user requires two-factor authentication. In some embodiments, the user query comprises the user's voice. In some embodiments, the plurality of indices are reduced in number by pre joining two or more of the plurality of indices.

### BRIEF DESCRIPTION OF THE DRAWINGS

A better understanding of the features and advantages of the present invention will be obtained by reference to the following detailed description that sets forth illustrative embodiments and the accompanying drawings of which:

FIG. 1 shows a non-limiting example of a system architecture for the search engine of the present disclosure;

FIG. 2A shows a non-limiting example of a data structure for use with the current indexing system. Here patients are aligned in rows, and genomic variants that the individuals' possess, compared to a reference genome, are listed in columns;

FIG. 2B shows a non-limiting example of a data structure for use with the current indexing system. Here search terms (e.g., keywords) are aligned in rows, and genomic variants associated with the term are listed in the columns;

FIG. 2C shows a non-limiting conceptual example of data connections. In this example, a K is an individual's genome, a T is a term and a C is an individual genomic variant;

FIG. 2D shows a non-limiting conceptual example of data organization. For example, genes can be associated with other genes, pathways, and genomic variants (CPRA). Terms can be associated with other terms, keywords, and genes;

FIG. 3 shows a non-limiting example of a user interface of the platforms, systems, media, and methods described herein; in this case, a single search box allows users to enter different queries and receive ranked results (e.g., the user enters the term “cancer” and results are returned that list genomic variants that have an association with cancer);

FIG. 4 shows a non-limiting example of search syntax that can be used with the platforms, systems, media, and methods described herein; in this case, a single search box allows users to enter different queries and receive ranked results. In certain embodiments, this box is displayed on the initial search page;

FIG. 5 shows additional non-limiting examples of search syntax that can be used with the platforms, systems, media, and methods described herein. In certain embodiments, this box is displayed on the initial search page;

FIG. 6 shows a non-limiting example of search results obtained with a particular syntax, “@john homozygous melanoma;”

FIG. 7 shows a non-limiting example of search results obtained with a particular syntax “@kid-@mom-@dad pathogenic;”

FIG. 8A shows a non-limiting example of search results returned from a user query;

FIG. 8B shows a non-limiting example of search results returned from a user query;

FIG. 9 shows an exemplary ranking hierarchy;

FIG. 10 shows a non-limiting example of a ranking hierarchy applied to multiple results;

FIG. 11 shows a conceptual architecture for an evaluation corpus;

FIG. 12 shows a non-limiting algorithm for variant anal lysis blending both manual and automatic annotation;

FIGS. 13A and 13B show non-limiting examples of search results returned from a user query; in these cases, non-limiting examples of a user feedback module;

FIG. 14 shows a non-limiting example of a custom ranking search detailed in Example 4;

FIGS. 15A and 15B show a non-limiting example output of an individual's or medical search of their own gene variants. This search could also be performed by a medical service provider or physician;

FIG. 16 shows a non-limiting example output that visualizes the proportion of genomes in a database that possess a particular variant;

FIG. 17 shows a non-limiting example output that visualizes the association of a variant with a particular phenotypic trait (e.g., BMI, height, weight, blood glucose, etc.) in individuals that have had their genomic and phenotypic data added to a database (associations are shown by a box and whisker plot based on zygosity for the genomic variant);

FIG. 18 shows a non-limiting example of a portal that allows a user to input their own genomic data or a custom data set;

FIGS. 19A and 19B show a non-limiting example of phenotype/genotype plotting showing distribution of height in males and females (FIG. 19A) and chromosome copy number variation and gender (FIG. 19B);

FIGS. 20A and 20B show a non-limiting example of a personal genome upload showing the Uploading 3^{rd}-party genotypes for a family trio (FIG. 20A) and analysis of the uploaded trio in the context of variant data (FIG. 21B); and

FIGS. 21A and 21B show a non-limiting example of a real-time GWAS showing an interactive Genome-Wide Association Study (GWAS) on BMI (FIG. 21A) and BMI correlates with the presence of a mutation (FIG. 21B).

### DETAILED DESCRIPTION OF THE INVENTION

Described herein, in certain embodiments, are computer-implemented systems comprising: a computer storage, a digital processing device comprising: at least one processor, an operating system configured to perform executable instructions, a memory, and a computer program including instructions executable by the digital processing device to create a genomic search engine application comprising: a plurality of indices, recorded in the computer storage, the indices comprising tokenized genomic data; a software module providing an indexing pipeline, the indexing pipeline ingesting genomic data and annotation associated with the genomic data, tokenizing the data while preserving gene names and gene variant names, and updating the indices with the tokenized data; a software module presenting a user interface allowing a user to enter a user query; and a software module providing a query engine, the query engine accepting the user query, selecting one or more relevant indices, and applying a ranking formula to the selected indices to return ranked results.

Also described herein, in certain embodiments, are non-transitory computer-readable storage media encoded with a computer program including instructions executable by a processor to create a genomic search engine application comprising: a plurality of indices, recorded in the computer storage, the indices comprising tokenized genomic data; a software module providing an indexing pipeline, the indexing pipeline ingesting genomic data and annotation associated with the genomic data, tokenizing the data while preserving gene names and gene variant names, and updating the indices with the tokenized data; and a software module presenting a user interface allowing a user to enter a user query; a software module providing a query engine, the query engine accepting the user query, selecting one or more relevant indices, and applying a ranking formula to the selected indices to return ranked results.

Also described herein, in certain embodiments, are computer-implemented methods of providing a genomic search engine comprising: storing a plurality of indices in a computer storage, the indices comprising tokenized genomic data; providing an indexing pipeline, the indexing pipeline ingesting genomic data and annotation associated with the genomic data, tokenizing the data while preserving gene names and gene variant names, and updating the indices with the tokenized data; presenting a user interface allowing a user to enter a user query; and providing a query engine, the query engine accepting the user query, selecting one or more relevant indices, and applying a ranking formula to the selected indices to return ranked results. In a certain embodiment indices are optimally formatted in a partially pre-joined configuration such that search speed is increased and a lag time between search and results is reduced. For example, an original plurality of indices comprising genomic data can be pre-joined to reduce the total number of indices 2-fold, 3-fold, 4-fold, 5-fold, 6-fold, 7-fold, 8-fold, 9-fold, 10-fold or more to allow for faster and optimized searching. In some embodiments, the plurality of indices are reduced in number by pre joining 2, 3, 4, 5, 6, 7, 8, 9, 10 or more of the plurality of indices. In some embodiments, the plurality of indices are reduced in number by pre-joining 20, 30, 40, 50, 60, 70, 80, 90, 100 or more of the plurality of indices. In some embodiments, pre-joining occurs before the user enters a query.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

Unless otherwise specified as used herein “about” means within the stated amount by 10%, 5%, or 1%.

### Architecture

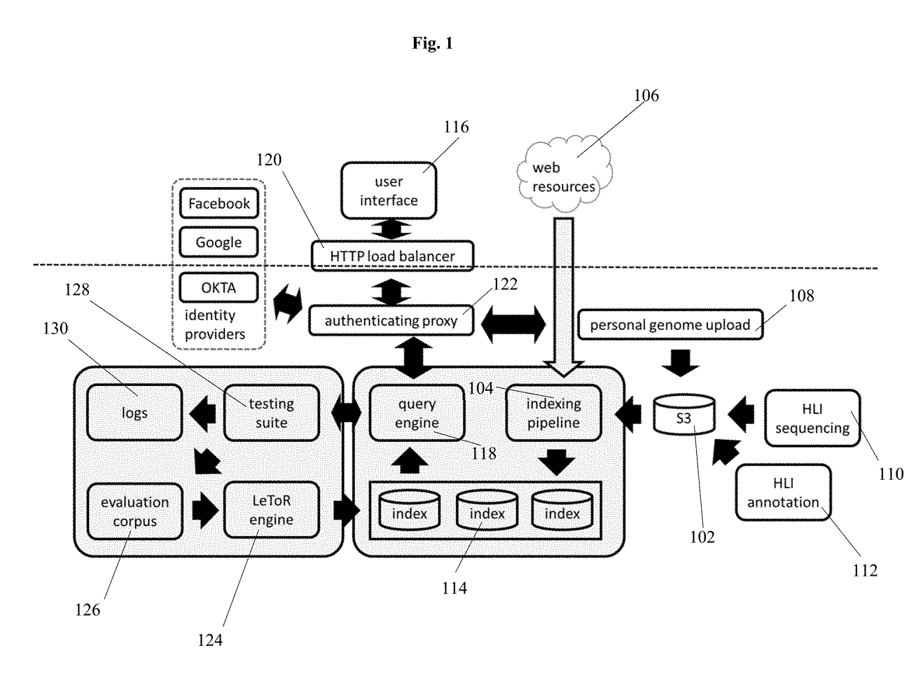

A search engine architecture is deployed and is adapted to the specific needs for genomic and structured data. The architecture consists of four major components: (i) a browser-based user interface; (ii) a query engine that responds to requests; (iii) an indexing pipeline; and (iv) a relevance-learning system. The overall function of the user interface (UI) is to present a unified and highly responsive way for querying and navigating the search results. The UI is the only component of the system that actively maintains the state of the search session. The UI accepts user queries, relays them to the query engine, renders the resulting ranked list, and allows the user to interact with search results in two distinct ways: (a) relevance feedback—a thumbs-up/down type assessment of how well a result answers their information need; and (b) comments on the accuracy of the information presented by a search result (e.g., a ClinVar record being out of date). In certain embodiments, the UI is required to be: (1) instantly responsive, (2) informative, and (3) unambiguous. FIG. 1 is a non-limiting example of a system architecture that can implement the methods of this disclosure. Data (S3) 102 can be added to an indexing pipeline 104 from web resources 106, genomes uploaded by an individual user, researcher, or health care provider (personal genome upload) 108; genomes uploaded directly by a sequencing service (e.g., HLI sequencing) 110, and from annotation curated by expert users, or the entity controlling the search engine (e.g., HLI annotation 112). The data added by the indexing pipeline 104 is stored in one or more indexes 114. The user interface 116 allows a user to enter queries and receive results by the query engine 118. In certain embodiments, this requires an HTTP load balancer 120. In certain embodiments, this requires an authenticating proxy 122. The results retrieved from the indexes 114 are ranked by the LeToR engine (Learning To Rank) 124. The rules for ranking results are contained in the evaluation corpus 126. In this example, a testing suite 128 allows for monitoring and refining of results and delivering data in the form of a log 130.

### Indexing Pipeline

In some embodiments, the platforms, systems, media, and methods described herein include an indexing pipeline, or use of the same. In certain embodiments, the indexing pipeline is responsible for the following four tasks: (a) ingesting the diverse sources of genomic and annotation data as they are released or updated, (b) parsing and converting them to a unified form, (c) updating the indices used by the query engine and the relevance-learning system, and (d) propagating the indices to multiple query-engine nodes as necessary. In certain embodiments, the indexing pipeline allows for: (1) timely coverage of all relevant resources, (2) accurate domain-specific tokenization/unification of terms in every source, and (3) high throughput for frequent index updates. In some embodiments, the indexing pipeline collects and parses or tokenizes data before indexing. In certain embodiments, the indexing pipeline compresses the tokenized data. In some embodiments, the data that is tokenized by the indexing pipeline is genomic data, metabolomic data, microbiome data, phenotypic data, or physiological data.

Conventional tokenization algorithms operate by either (i) treating non-alphanumeric characters as boundaries for indexing units; or (ii) removing non-alphanumeric characters; or some combination of (i) and (ii). This approach fails for identifiers commonly used in genomic texts. For example, a DNA mutation may be identified by the Human Genome Variation Society (HGVS) with the following literal string of characters: “c.[=//83G>C]”. A conventional parser would convert the mutation identifier either to (ii) a single indexing unit “c83GT”; or to (i) a trio of independent indexing units: “c”, “83G” and “C”. Neither (i) nor (ii) provides adequate representation of the mutation. Similar issues occur for other concepts in genomic and biological texts, for example gene names, chemical compounds and numeric/percentile quantities. We overcome these issues with a three-step algorithm: (1) we apply a sequence of pattern-matching rules that identify and extract known entities within text; (2) we apply two heuristic rules to tokenize text into entities: (2a) characters of class A (& ! ”$ % * < >? @ # \=) are replaced with spaces; (2b) characters of class B (, . : ; ( ) [ ] ′ /) are removed if immediately adjacent to a space; and (3) we apply standard search-engine tokenization and reduce the resulting indexing units to their root form with the Krovetz stemmer. In some embodiments, the tokenization algorithm does not remove non-alphanumeric characters. In some embodiments, the tokenization algorithm does not treat non-alphanumeric characters as boundaries for indexing units.

In some embodiments, the indexing pipeline is optimized to tokenize genomic data. In certain embodiments, the genomic data described herein include nucleotide sequence data. In certain embodiments, the nucleotide sequence data is a DNA sequence, an RNA sequence, a cDNA sequence, or any combination thereof. In certain embodiments, the genomic data are gene names, gene symbols, or gene coordinates. In certain embodiments, the genomic data is a string of nucleotides greater than 1 nucleotide in length. In certain embodiments, the genomic data is a string of nucleotides greater than 10 nucleotides in length. In certain embodiments, the genomic data is a string of nucleotides greater than 100 nucleotides in length. In certain embodiments, the genomic data is a string of nucleotides greater than 1,000 nucleotides in length. In certain embodiments, the genomic data is a string of nucleotides greater than 10,000 nucleotides in length. In certain embodiments, the genomic data is a string of nucleotides greater than 100,000 nucleotides in length. In certain embodiments, the genomic data is a string of nucleotides greater than 1,000,000 nucleotides in length. In certain embodiments, the genomic data is a string of nucleotides greater than 1,000,000 nucleotides in length. In certain embodiments, the genomic data is a string of nucleotides greater than 10,000,000 nucleotides in length. The genomic data can comprise data from a plurality of genomes in excess of 1,000; 5,000; 10,000; 20,000; 30,000; 40,000; 50,000; 60,000; 70,000; 80,000; 90,000; 100,000; 200,000; 300,000; 400,000; 500,000; 600,000; 700,000; 800,000; 900,000; or 1,000,000 genomes, including increments therein. The data can comprise just the variants and their association with an individual's and their phenotypic data. Data can be formatted in any suitable format including FASTA, .txt, .vcf, or a proprietary format from a genome sequencing service. The data can comprise a list of single nucleotide polymorphisms and associated rs numbers.

In some embodiments, the indexing pipeline is optimized to tokenize metabolomic data. In certain embodiments, the metabolomic data includes metabolites such as of specific carbohydrates, specific lipids, specific amino acids, specific proteins, aspartate aminotransferase, alkaline phosphatase, aspartate aminotransferase, prostate specific antigen, hormones, insulin, glucagon, leptin, adiponectin, fatty acids, non-esterified fatty acids, omega-3 fatty acids, cholesterols, high-density lipoprotein (HDL), low-density lipoprotein (LDL), very low-density lipoprotein (VLDL), chylomicrons, triglycerides, diglycerides, monoglycerides, carbohydrates, sugars, glucose, glycogen, bile acids, bilirubin, bile salts, electrolytes, calcium, sodium, potassium, magnesium, chloride, bicarbonate, blood pH, hemoglobin, hemoglobin A1c, white blood cell counts, blood pressure. In certain embodiments, the indexing pipeline is optimized to tokenize concentrations of metabolites. In certain embodiments, the indexing pipeline is optimized to tokenize concentrations of metabolites in picograms (pg), nanograms (ng), micrograms (μg), milligrams (mg), grams (g), or kilograms (Kg); per microliter (μL), milliliter (mL), centiliter (cL), deciliter (dL) or liter (L). In certain embodiments, the concentration is expressed as units per milliliter (U/mL), units per centiliter (U/cL), units per deciliter (U/dL), units per Liter (U/L), milligrams per milliliter (mg/mL), milligrams per centiliter (mg/cL), milligrams per deciliter (mg/dL), milligrams per Liter (mg/L), grams per milliliter (g/mL), grams per centiliter (g/cL), grams per deciliter (g/dL), grams per Liter (g/L), moles per milliliter (mol/mL), moles per centiliter (mol/cL), moles per deciliter (mol/dL), moles per Liter (mol/L). In certain embodiments, the concentration is expressed as molarity (M) or molality (m).

In some embodiments, the indexing pipeline is optimized to tokenize microbiomic data. In certain embodiments, the indexing pipeline is optimized to tokenize genus, species, and strain names. In some embodiments, the indexing pipeline is optimized to tokenize abundance of microbial species. In some embodiments, the indexing pipeline is optimized to tokenize 16S ribosomal subunit sequence information. In some embodiments, the indexing pipeline is optimized to tokenize abundance of microbial species such as reads per million, reads per billion, colony forming units (CFU), and/or plaque forming units (PFU).

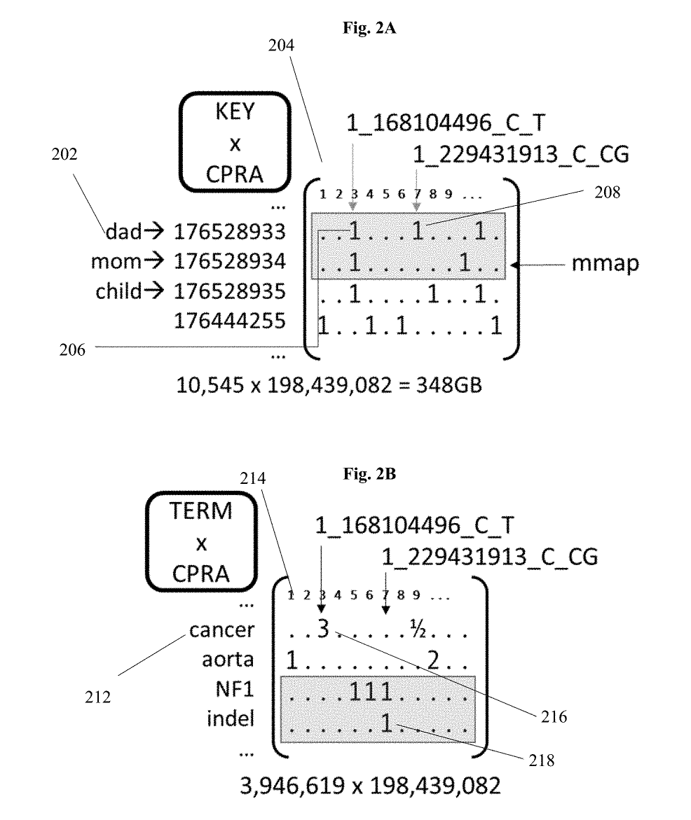

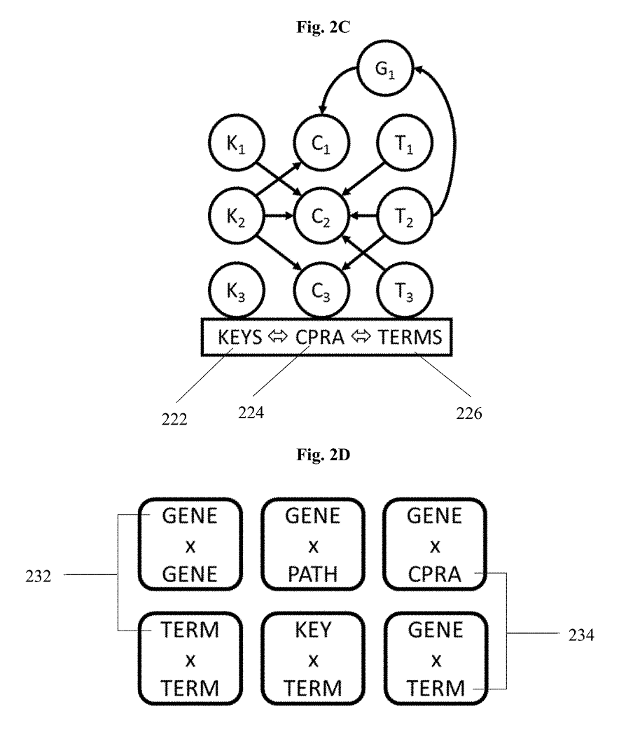

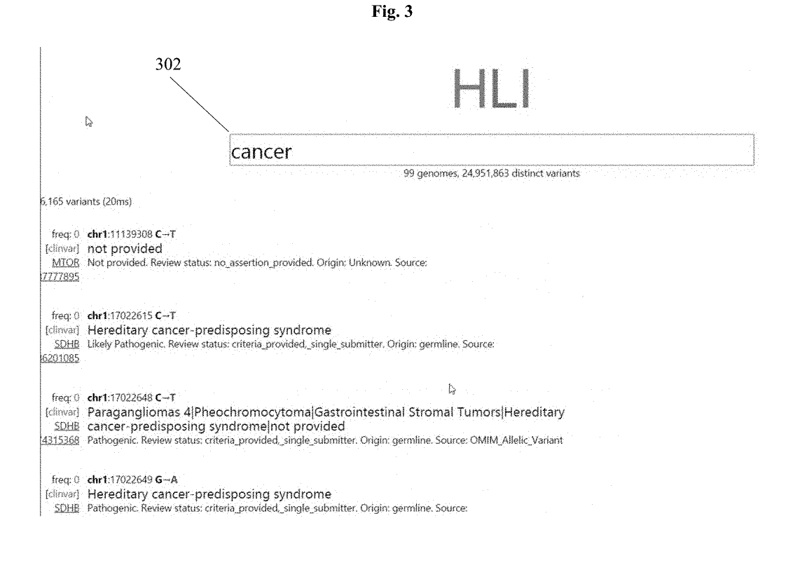

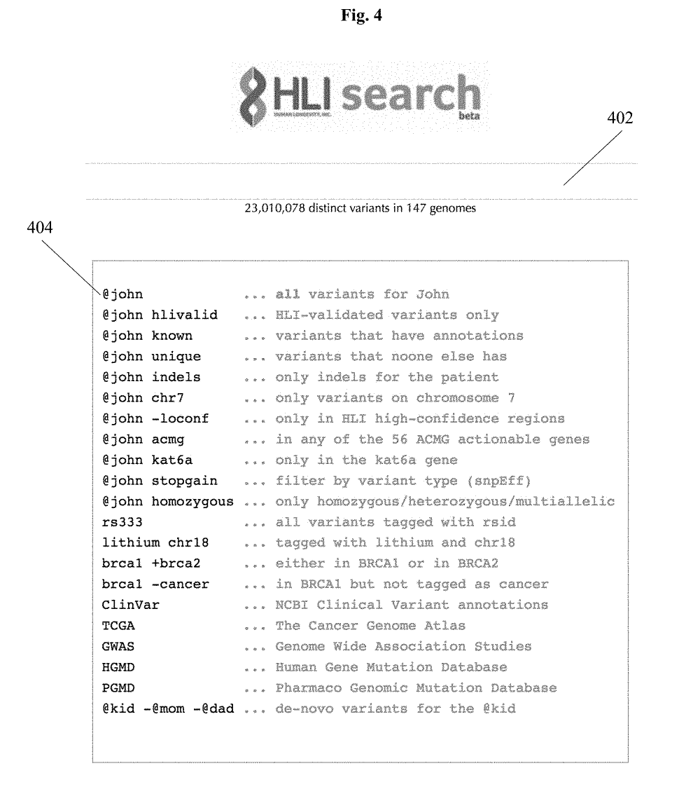

FIGS. 2A and 2B show non-limiting examples of a data index. In a certain embodiment, data is indexed in rows and columns. In FIG. 2A, a row 202 represents an individual and each column 204 represents a genomic position and a genomic variant (e.g., variants with respect to a reference genome) from that patient. For example, the “1” in column 3 for the “dad” row corresponds to the presence of the variant 206 designated as “1_168104496_C_T”, which refers to: on chromosome 1, at position 168104496, a C is replaced by a T. Mom (row 2) and child (row 3) also have this same variant, but the individual genome shown in row 4 does not have this variant. Similarly, the “1” in column 7 for dad corresponds to the presence of the variant 208 designated as “1_229431913_C_CG”, which means that on chromosome 1, at position 229431913, a C is replaced by CG (i.e., a G is inserted after the C). In this case, neither mom nor child has this particular variant. In certain embodiments, the index only contains genomic variants and patient identifiers. In certain embodiments, multiple genomic variants are stored in each column. In certain embodiments, each variant is stored in single column. In certain embodiments, the gene variant stored can be a point mutation, indel, translocation, copy number variation, zygosity of a given genomic variant, or any combination thereof. In some embodiments, the number of rows is expandable to the number of patients or individuals within a given index (e.g., all clients or patients associated with a particular study). In some embodiments, the number of rows is expandable to the number of terms or keywords within a given index. In certain embodiments, each column represents a position and a gene variant. In FIG. 2B, a row 212 represents a particular search term and column 214 represents a genomic variant associated with that term. In certain embodiments, the column contains a confidence level that is representative of the confidence that a particular genomic variant is associated with a particular term (e.g., the confidence that a certain variant is associated with cancer). In the specific example shown in FIG. 2B, the confidence level 216 “3” shown in column 3 of the “cancer” search term (row 1) means that there is high confidence that cancer is associated with a replacement of a C with a T at position 168104496 of chromosome 1. Similarly, the confidence level 218 “1” in column 7 in the NF1 search term (row 3) means that the association of a G insertion after the C at position 229431913 of chromosome 1 is possibly associated with NF1, but the confidence level for this association is less than for above-described cancer-associated variant. In certain embodiments, an index comprises at least one million columns. In certain embodiments, an index comprises at least two million columns. In certain embodiments, an index comprises at least three million columns. In certain embodiments, an index comprises at least five million columns. In certain embodiments, an index comprises at least ten million columns. In certain embodiments, an index comprises at least 100 million columns. In certain embodiments, an index comprises at least 200 million columns. In certain embodiments, an index comprises at least 300 million columns. In certain embodiments, an index comprises at least 500 million columns. In certain embodiments, the data structure of all indices (e.g., rows and columns) is the same.

In FIG. 2C, a simplified schematic representation is shown that depicts interactions with different indices, including those for keys 222, CPRA 224, and terms 226. This representation is infinitely expandable. For example, a certain term T₂ may be associated with multiple genomic variants C₂ and C₃. Further, a genome K₂ can be associated with multiple genomic variants C1, C₂ and C₃. The genome belonging to K₂ can have a variant C1 that is associated with a gene G₁ that is associated with phenotypic term T₂ in this way, and through multiple iterations, data networks can evolve and expand.

FIG. 2D shows examples of indexes that can be created by the indexing pipeline. In certain embodiments, the rows 232 optionally represent patients, genomes, genes, terms, genetic variants, phenotypes, metabolome data, and microbiome data. In certain embodiments, the columns 234 optionally represent patients, genomes, genes, terms, genetic variants, phenotypes, metabolome data, and microbiome data. These examples are not limiting and encompass types of data, metadata, and data labels.

Indices formulated as in FIG. 2A-2D can be advantageously deployed by pre-joining certain indices (formatted as tables) to increase speed and efficiency of a search. The ideal number of pre-joined tables can be greater than 10 and less than 100, greater than 5 and less than 80, greater than 10 and less than 70, greater than 20 and less than 60, greater than 30 and less than 50. These pre-joined tables can be generated from greater than 10, 20, 30, 40, 50, 60, 70, 80, 90, 100, 200, 300, 400, 500, 600, 700, 800, 900, or 1000 tables, including increments therein. Pre-joining tables in this way can increase speed about 2-fold, 3-fold, 4-fold, 5-fold, 6-fold, 7-fold, 8-fold, 9-fold, 10-fold or more over non pre-joined tables. Absolute time from query to results can be less than about 2 seconds, 1 second, 900 milliseconds, 800 milliseconds, 700 milliseconds, 600 milliseconds, 500 milliseconds, 400 milliseconds, 300 milliseconds, 200 milliseconds, 100 milliseconds or less, including increments therein, for queries that exceed nucleotide data from greater than the equivalent of 10,000; 20,000; 30,000; 40,000; 50,000, 60,000; 70,000; 80,000; 90,000; 100,000; or 200,000 human genomes, including increments therein. Absolute time from query to results can be less than about 2 seconds, 1 second, 900 milliseconds, 800 milliseconds, 700 milliseconds, 600 milliseconds, 500 milliseconds, 400 milliseconds, 300 milliseconds, 200 milliseconds, 100 milliseconds or less, including increments therein, for queries that exceed nucleotide data from greater than the equivalent of 1×10⁶, 2×10⁶, 3×10⁶, 4×106, 5×10⁶, 1×10⁷, 1×10⁸ genomic variants or mutations, including increments therein.

### Query Engine

In certain embodiments, the query engine is a stateless server that accepts user queries (e.g., as HTTP POST requests) and responds with a ranked list of results (e.g., as asynchronous JSON), based on a collection of pre-computed index files. In certain embodiments, the query engine performs the following functions: (a) parses the query and classifies user intent (e.g., does the user want variants or PubMed publications), (b) provides query corrections and suggestions to the UI, (c) selectively expands the query with relevant synonyms, (d) decides on the appropriate indices to use, (e) ranks all results by their relevance to the predicted query intent (e.g., pathogenicity for some queries, frequency for others, etc), and (f) handles interaction/feedback signals from the UI. In certain embodiments, the query engine allows for: (1) sub-second latency on every query and (2) scalability to hundreds of concurrent users. The query engine is optimized to be queried by any one or more of a biomedical scientist, a technician, a genetic counselor, and a medical professional (such as a doctor, a nurse, a nurse practitioner, or anyone else certified to provide medical care). The query engine allows for simplified search syntax such that an individual with little genetic training or bioinformatics training could query the search engine and search for unique variants, variants shared with other individuals (e.g., a child or parent) or variants that have been designated as medically actionable by experts or statistical analysis.

### User Query, Inputs, and Outputs

In some embodiments, the platforms, systems, media, and methods described herein include an interface allowing a user to enter a user query, or use of the same. In certain embodiments, the user query can be by speech. In some embodiments, the user query includes a certain gene name or gene symbol, a patient/individual ID number, a phenotype or physiological trait. In certain embodiments, all synonyms for certain gene names will be treated the same. In some embodiments, users can input a designator for a single nucleotide polymorphism, such as an rs number (e.g., rs12345, rs123456, rs1234567, rs12345678). In some embodiments, the input is a check box or clickable button that restricts or filters the output to sequence variants, diseases, phenotypic data, metabolomic data, demographic data, common variants, uncommon variants, and statistically significant variants. In certain embodiments, the results are sortable, able to be designated as favorite, or exported to another program. In certain embodiments, individual search terms are combinable or able to be layered. In certain embodiments, an individual can search within a certain set of results for additional information using additional user queries or filtering. Table 1 exemplifies some embodiments of the information desired example user input, and example output. Table 1 is not an exclusive or exhaustive list of queries that can be deployed by a user.

TABLE 1

| Type of information desired by user | Example user input | Example output |
|---|---|---|
| Gene variants associated with | “BRCA1 variants” or “breast | Will at least output a list of |
| certain genes | cancer 1 variants” “or BRCA1 | sequence variants or |
| | variants within 1 kilobase” or | insertion/deletion mutations |
| | “BRCA1variants in exons” or | associated with the entered gene |
| | “BRCA1variants in coding regions” | or gene feature or within a |
| | or “BRCA1 variations within 1 kilo | certain amount of nucleotides |
| | base of the transcriptional start site” | from the boundaries of the |
| | or BRCA1 index | specified elements |
| Sequence variants associated with | “BRCA1 variants greater than 0.1” | Will at least output all sequence |
| certain genes that have a frequency | or “BRCA1 variants less than 0.01” | variants associated with a gene |
| above or below a certain threshold | or BRCA1 variants between 0.01 | that have less than, greater than |
| | and 0.1 | or in a certain range of specified |
| | | allele frequencies |
| Variants for a person or patient | User initials such as “abc” or “abc | Will at least output all sequence |
| | variants” or unique patient number. | variants associated with a |
| | (e.g., “ABC12345” or “ABC12345 | unique patient number or that |
| | variants” or “ABC12345 and | are common amongst more than |
| | ABC67890 common variants”) | one patient |
| Variants that relate to a certain | “abc melanoma” or “abc diabetes | Will at least output all known |
| phenotype or risk factor for a | risk” or “ABC12345 diabetes” or | sequence variants associated |
| person or patient | “ABC12345 cardiovascular | with a certain disease and that |
| | disease” | are present in the sequence |
| | | associated with a unique patient |
| | | number |
| All pathogenic variants in a | “abc pathogenic” or “abc disease” | Will at least output all sequence |
| genome | or “abc risk variants” or | variants present in the sequence |
| | “ABC12345 pathogenic” or | associated with a unique patient |
| | “ABC12345 disease” or | number and that are known to |
| | “ABC12345risk variants” | be associated with a certain |
| | | disease |
| People or patients that have a | “rs1232567” | Will return all patient IDs that |
| certain variant | | contain a certain sequence |
| | | variant that the user has |
| | | permission to access |
| Correlating genotype with | “rs1232567~height” or | Will at least output a probability |
| phenotype | “rs1232567~diabetes” or | that a certain sequence variant is |
| | “rs1234567 and BMI” | associated with the given trait or |
| | | disease |
| Variants that relate to height (in | “sequence variants associated with | Will at least output variants that |
| effect running a genome-wide | height” or “top 50 sequence | are associated with a certain |
| association study): | variants associated with height” or | trait ranked by significance or |
| (“chr1:*~height”) | “indels associated with height” or | that meet a user specified |
| | “sequence variants associated with | significance level |
| | height with a p value less than | |
| | 0.0000001” | |
| People and how they relate to a | “patients with a sequence | Will output all patient |
| certain gene, e.g., everybody that | variation in BRCA1” or | numbers associated with a |
| has a truncated gene or a | “patients with an indel in | genome sequence that |
| ‘mutational load’ (“BRCA1”) | BRCA1” | possess the type of variant |
| | | specified |
| Unique sequence variants between | “ABC12345-ABC67890” | Will at least output sequence |
| two individuals | | variants in ABC12345 but not in |
| | | ABC67890 |

In some embodiments, the platforms, systems, media, and methods described herein include synonym dictionaries that enable a query using very flexible natural language search terms. In certain embodiments, the synonym dictionary includes synonyms for diseases, gene names, phenotypic traits, test results, bacterial genera and species, and demographic signifiers.

### Query Engine

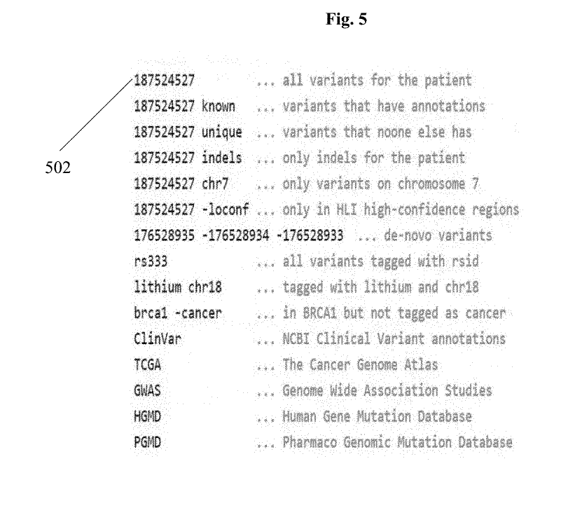

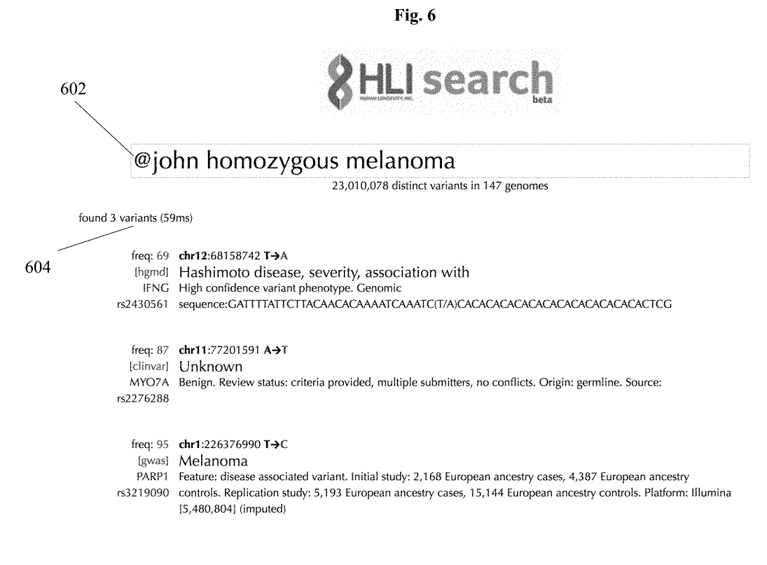

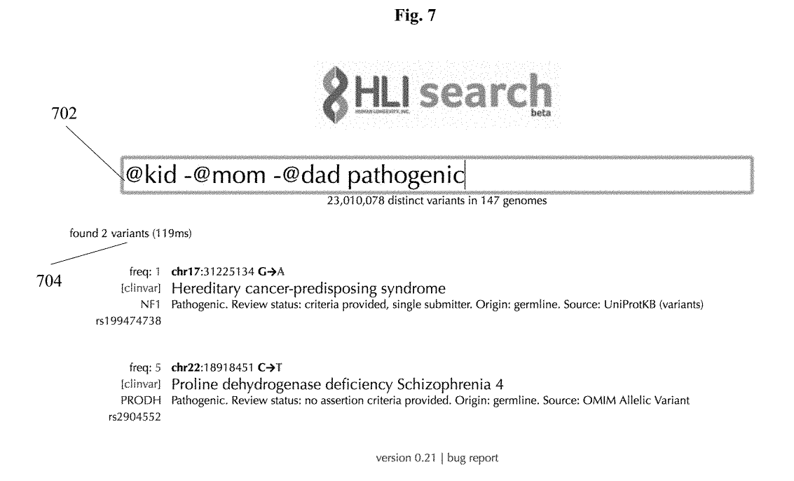

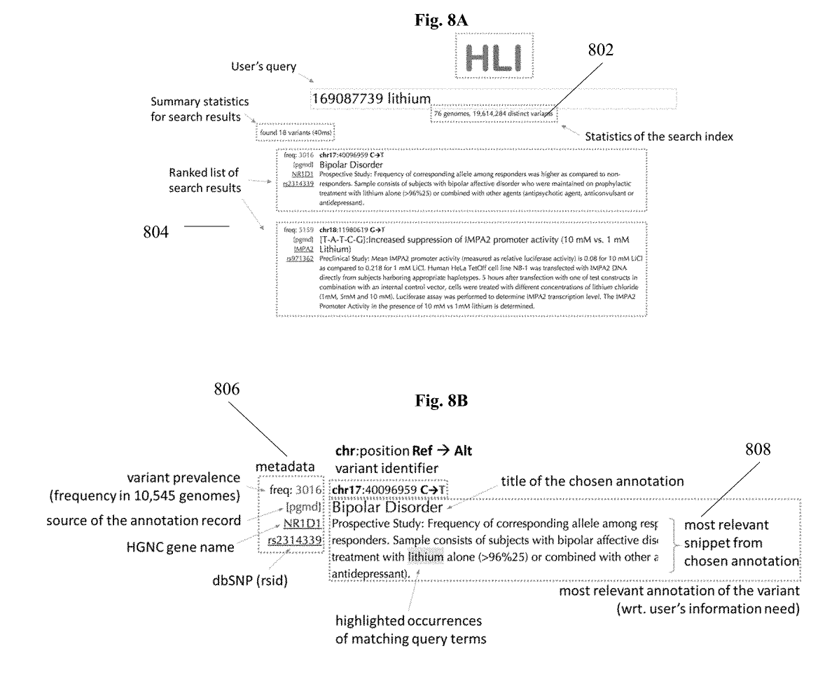

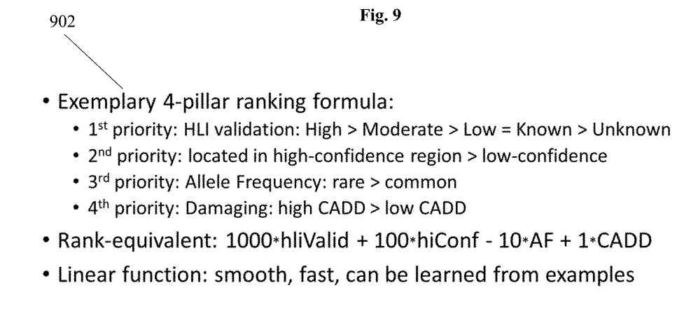

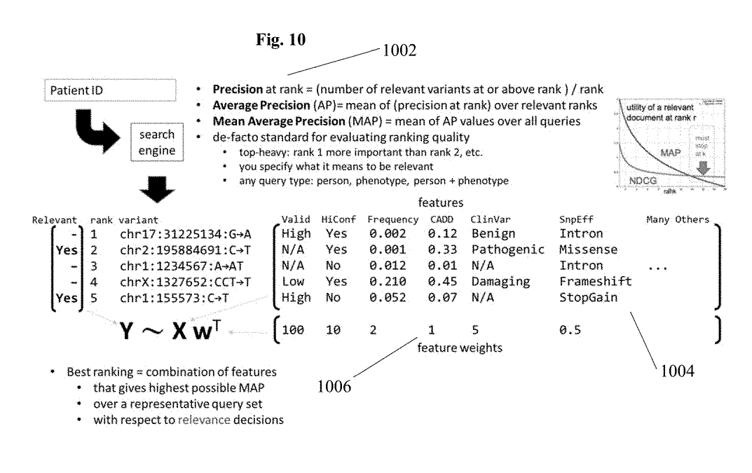

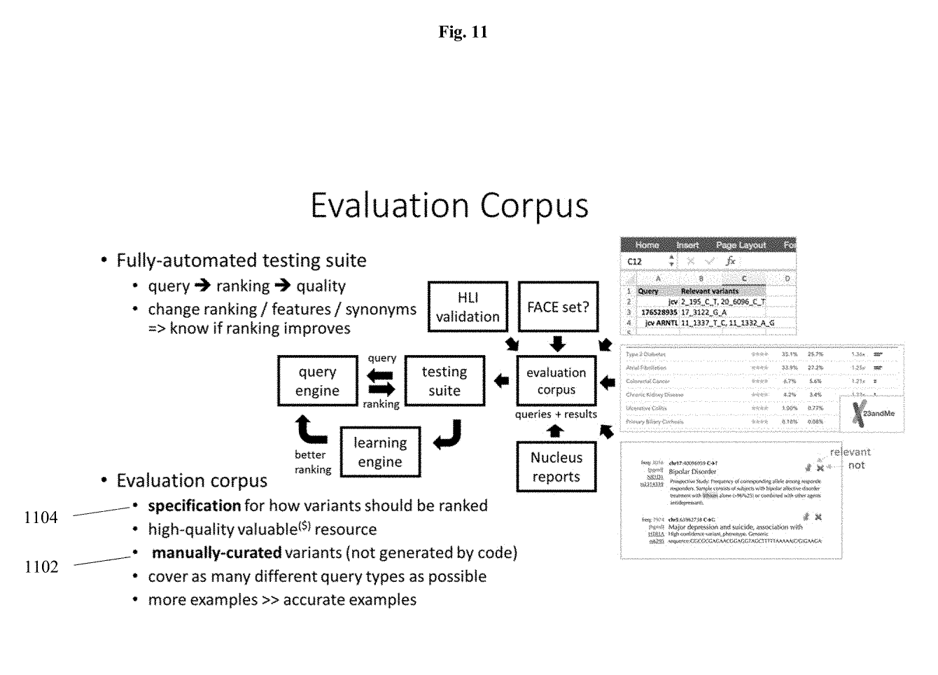

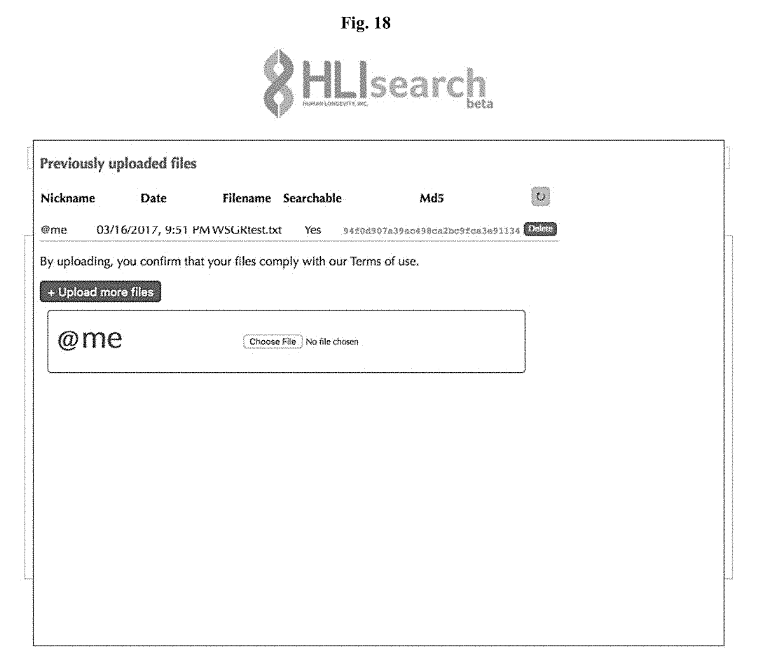

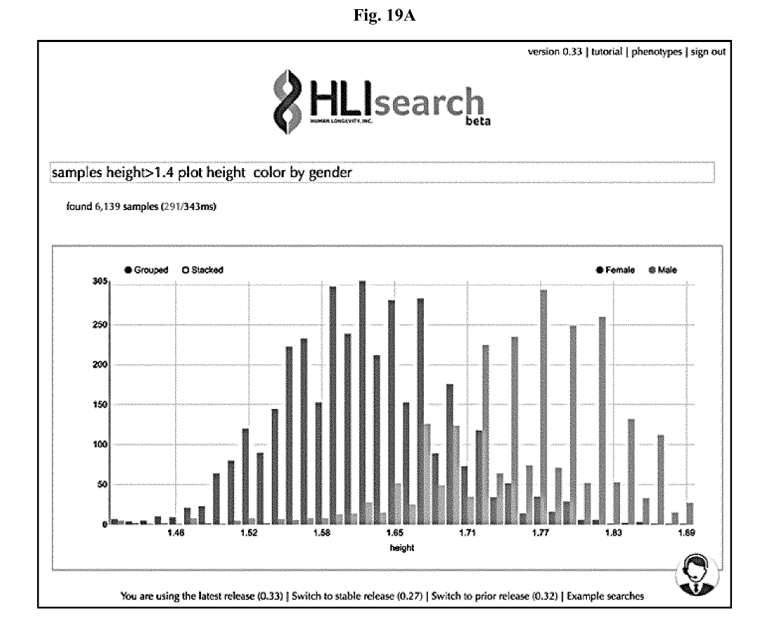

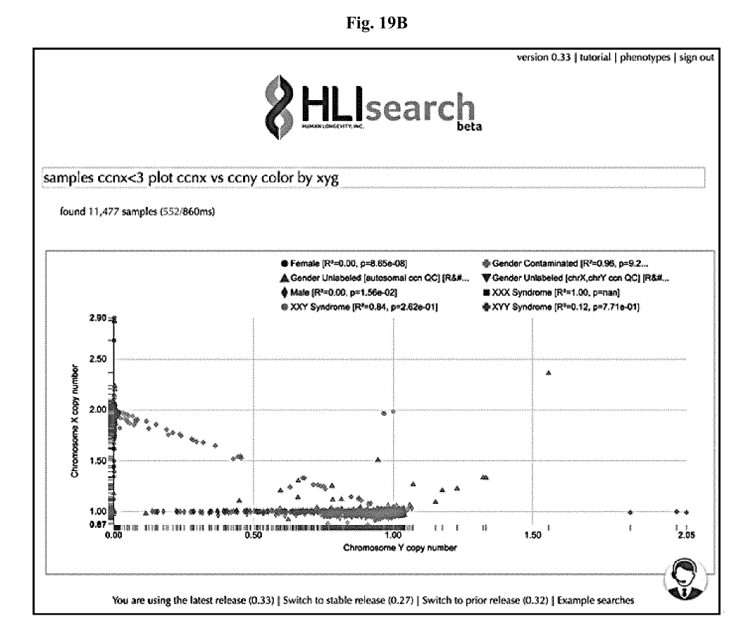

In some embodiments, the platforms, systems, media, and methods described herein include a query engine, or use of the same. In reference to FIGS. 3-8, in some embodiments, users type their queries into a single search box 302. (See FIG. 3). In some embodiments, the search page comprises a single search box 402 and a list of available syntax 404 (See FIG. 4). FIG. 5 shows additional non-limiting examples of search syntax 502. FIG. 6 shows an example search string input into a search box 602 where a user “John” can find homozygous mutations 604 that have been associated with melanoma. FIG. 7 shows an example search string input into a search box 702 where a parent may look to find gene variants 704 present in a child but not in the parents (de novo mutations. FIGS. 8A and 8B show additional non-limiting examples of results returned for specific searches. As a user enters a query, statistics of the search index or indices 802 are displayed to the user. In response to the query, the database is searched, query hits are identified and are ranked, as discussed below, and a ranked list of search results 804 is presented to the user. Each search result includes metadata 806 and relevant annotations 808. In some embodiments, queries consist of (conceptually arbitrary) natural language terms combined with special operators (See FIG. 7). In some embodiments, special operators enable a user to unambiguously refer to certain information (e.g., a specific client) or impose certain constraints (e.g., provide only genes as results). In certain embodiments, the operators include but are not limited to: a plus sign, a minus sign, an equal sign, an ampersand, an asterisk, quotation marks, parenthesis, brackets, curly braces, a backslash, a forward slash, a colon, a semi-colon, a hash sign (#), an at sign (@), a tilde sign (˜), an equals sign (=), a greater than sign (>), a less than sign (<), and words AND, OR, NOT, EXCEPT. In certain embodiments, basic interaction with the system is very similar to a modern search engine. In certain embodiments, a user has an information need, types a query, looks at the search results and either modifies his query based on what he sees or interacts with the search results. Often interacting with a search result will result in a new search. In certain embodiments, the system will be highly interactive and questions are answered in a ‘dialog’ between human and machine. In certain embodiments, the user types a query into a single search box. In certain embodiments, queries consist of (conceptually arbitrary) natural language terms combined with special operators. In certain embodiments, special operators enable a user to unambiguously refer to certain information. In certain embodiments, special operators enable a user to unambiguously refer to a specific client/patient/individual. In certain embodiments, special operators enable a user to unambiguously refer to specific genes. In certain embodiments, special operators enable a user to unambiguously refer to specific positions in the genome. In certain embodiments, special operators enable a user to unambiguously refer to specific variations that do not have a fixed position on the genome, such as copy-number variation, gene-number variation, and chromosome-number variation. In certain embodiments, special operators enable a user to unambiguously refer to specific sequence variants. In certain embodiments, special operators enable a user to unambiguously refer to specific diseases. In certain embodiments, special operators enable a user to unambiguously refer to specific types of physiological data. In certain embodiments, special operators enable a user to unambiguously refer to specific types of microbial genera, species or strains. In certain embodiments, the system tries to guess query intent. In certain embodiments, special operators enable users to remove ambiguity. In certain embodiments, the search engine allows for the:
1. ability to plot phenotype and genotype values: a quick visual summary of search results (See FIG. 15 for an example output showing allele distribution and FIG. 16 for a plot of phenotype (BMI) vs zygosity (homozygous for major allele, heterozygous, or homozygous for minor allele));
2. ability to upload personal genomes and analyze them against the backdrop of a large proprietary or public database, for example, as shown in FIG. 17;
3. ability to upload new phenotypes and analyze them in the context of pre-existing large proprietary or public database (e.g., filter them, plot them, run GWAS over them);
4. ability to perform real-time, customizable genome-wide association studies (GWAS) over arbitrary phenotypes and cohorts;
5. ability to perform real-time burden tests on genes and pathways based on the variants in a given genome or family;
6. ability to automatically generate whole-genome-sequencing reports by querying the search index;
7. ability to quickly visualize the reads underlying a given mutation in an individual genome, or a family of genomes;
8. ability to analyze entire cohorts as a single genome;
9. ability to visualize variant residue on a 3d protein structure;
10. ability to save and recall sets of search results for later use;
11. intelligent auto-completion of queries; and
12. ability to query variants by a range of importance scores, including essentiality, conservation and intolerance.

### Ranking Formula

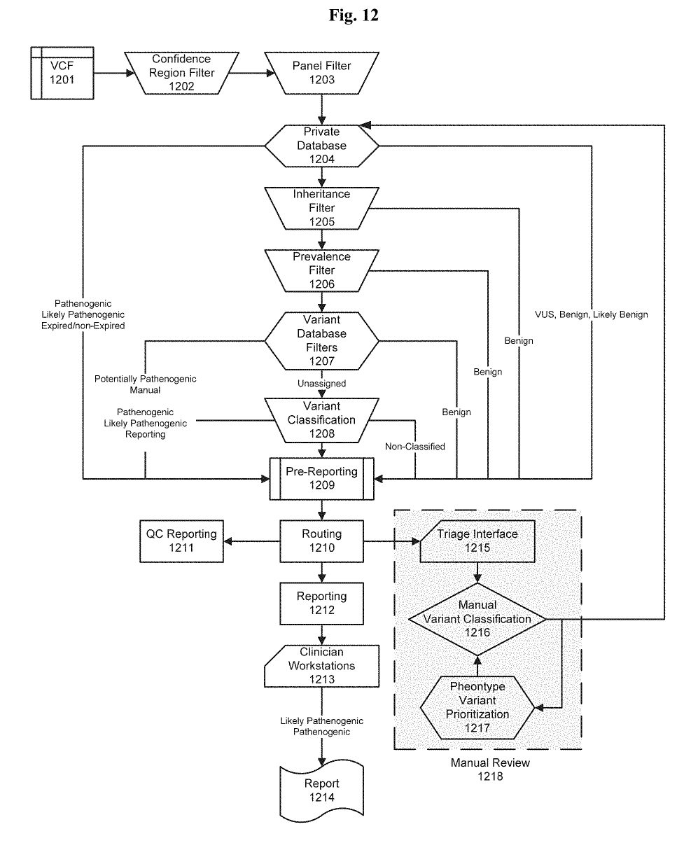

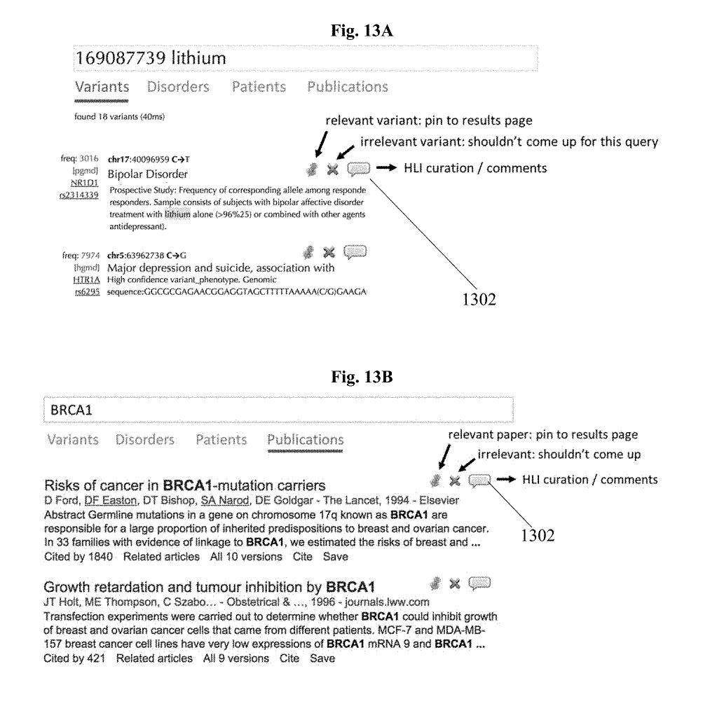

In order to return results relevant to a user the platforms, systems, media, and methods described herein deploy a ranking formula. The ranking formula comprises a set of weighted criteria that used to determine the relevance of a particular result. In certain embodiments, each criteria are weighted differently depending upon the particular relevance of the criteria. FIG. 9 depicts a non-limiting example of a ranking formula. This particular example utilizes four different criteria 902: a validation ranking (e.g., an internally developed ranking system, or a ranking system that is known to one or ordinary skill in the art), position of the variant in high confidence region of the genome, the allele frequency, and a CADD score (a method for scoring the deleteriousness of a given mutation; see, e.g., International Patent Application No. PCT/US2014/056701). The amount of criteria used to rank a given result can be expanded. In certain embodiments, the ranking formula uses a single criteria. In certain embodiments, the ranking formula uses at least two different criteria. In certain embodiments, the ranking formula uses at least three different criteria. In certain embodiments, the ranking formula uses at least four different criteria. In certain embodiments, the ranking formula uses at least five different criteria. In certain embodiments, the ranking formula uses at least six different criteria. In certain embodiments, the ranking formula uses at least seven different criteria. In some embodiments, the ranking formula uses at least 10 different criteria. In some embodiments, the ranking formula uses at least 100 different criteria. In some embodiments, the ranking formula uses at least 10 different criteria. In some embodiments, the ranking formula uses at least 1,000 different criteria. In some embodiments, the ranking formula uses at least 10 different criteria. In some embodiments, the ranking formula uses at least 10,000 different criteria. In some embodiments, the ranking formula uses at least 100,000 different criteria. In some embodiments, the ranking formula uses at least 200,000 different criteria. In some embodiments, the ranking formula uses at least 500,000 different criteria. In certain embodiments, the ranking formula is active and uses empirical data, knowledge, scores or algorithms. Examples of data that supports active ranking include allele frequency and counts. Examples of knowledge include the known or expected consequences of modifications of the genetic code (protein changes, truncation of proteins, frameshifts, substitutions, deletions, higher or lower expression of proteins, and disruption of functional elements). Examples of scores include indexes of severity, of mutation intolerance, of conservation, of positive or negative selection. Examples of algorithms include mathematical models of data trained against truth sets of human variants of known functional importance, protocols to identify gene essentiality, protocols to identify mutation intolerant sites, and machine learning and deep learning tools. In certain embodiments, the ranking formula is passive. Examples of passive approaches include learning from the search query terms used by client, from tools that support feedback, ranking and annotation/comments from users and experts. In certain embodiments, the ranking formula includes both active and passive ranking. In certain embodiments, the ranking formula includes either active or passive ranking. Active ranking is used where the software provided with the Search Engine contains data, knowledge, algorithms, scores that endow each response with a specific ranking. Passive ranking is used where the software provided with the Search learns from user(s) interaction the ranking of the responses to a query. FIG. 10 shows an example of performing precision-related calculations 1002 on several different genomic variants. A feature matrix 1004 is built for these genomic variants, and feature weights 1006 can be used to fine-tune the ranking process. Only certain genomic variants are relevant. In this example, all possible genomic variants are ranked without the application of a filter. In certain embodiments, no filter is applied by the ranking formula.

In certain embodiments, the ranking formula ranks information returned to a user by relevance to the input query. In certain embodiments, the ranking formula utilizes user input to rank specific results. In certain embodiments, the results are ranked by relevance to a particular user, a group of users, or a type of user. For example, a certain user such as a researcher may prefer slightly different results than a health care provider. In certain embodiments, the results are ranked based on the user being a researcher. In certain embodiments, the results are ranked based on the user being a health care provider. In certain embodiments, the results are ranked based on the user being a patient or individual.

### Relevance-Learning Engine

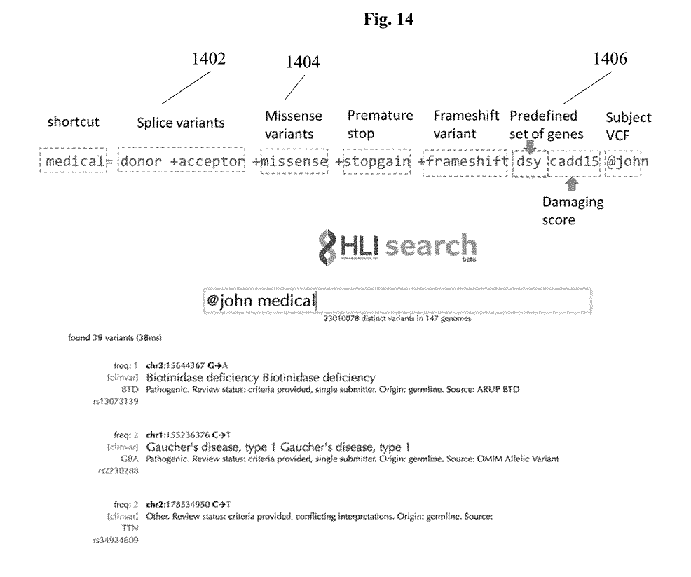

In some embodiments, the platforms, systems, media, and methods described herein include a relevance-learning engine, or use of the same. In certain embodiments, the relevance-learning engine interacts with an evaluation corpus to refine ranking results. In certain embodiments, the relevance-learning engine is responsible for the quality of the rankings, i.e., for putting the most useful results at the top for each query. In certain embodiments, the engine takes the representations produced by the indexing pipeline and the feedback signals recorded by the query engine, augments them with external sources, and learns the ranking formula that optimizes a chosen evaluation measure. In certain embodiments, the optimal formula is encoded by pre-computing special indices to be used by the query engine. In certain embodiments, the priorities for the relevance-learning system are: (1) a realistic but fully automated evaluation of ranking quality, (2) high accuracy with respect to the chosen evaluation measure, and (3) ranking formulae that can be efficiently encoded as indices. In certain embodiments, the overall data size that we expect to serve is such that the complete search engine can reside on a single machine and still be able to handle 1 million queries per day. In certain embodiments, the engine is scaled by replicating the machine multiple times and introducing a load balancer. FIG. 11 shows an example schematic of how the relevance learning engine interacts with the evaluation corpus. The evaluation corpus contains manually-curated genomic variants 1102 and specifications 1104 of how the genomic variants should be ranked. Each query generates a ranking of genomic variants and the quality of this ranking can be compared to user feedback on relevance that is integrated in the manual curation of these genomic variants. The evaluation corpus contains data from outside sources, internal validation and curation. Precision of results is measured based upon user feedback.

### Evaluation Corpus for Cancer Associated Variants

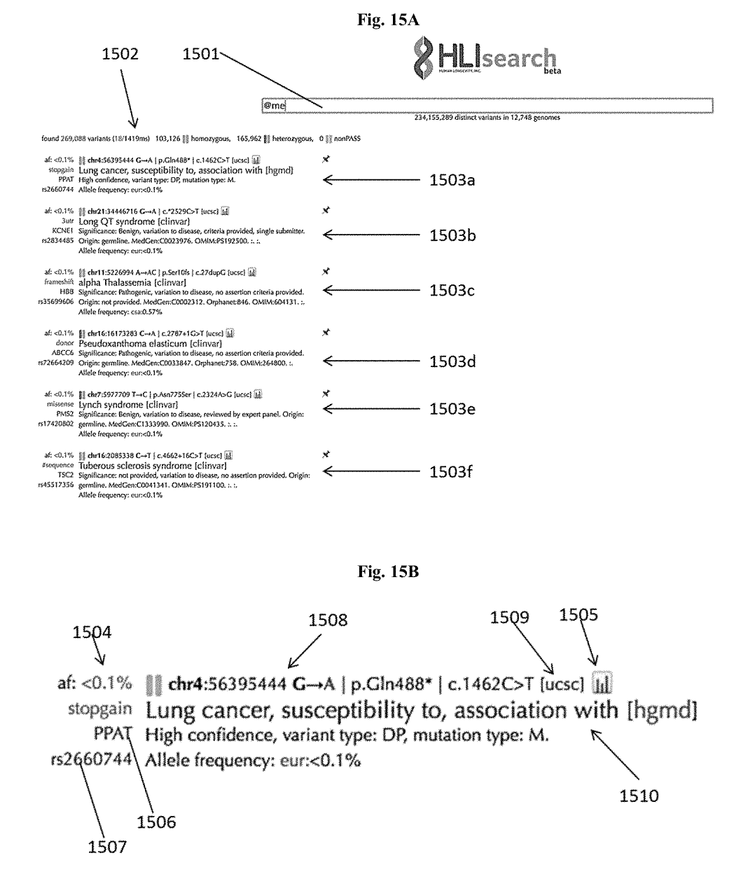

An exemplary system for automated variant call format (VCF) triage and annotation comprising a series of manual and automatic processes is shown per FIG. 12. In some embodiments, the system establishes an automated variant interpretation workflow that imports variants from external and internal databases, assigns classifications to variants without ACMG labels, and generates reports across multiple reporting pipelines, with or without manual intervention. In some embodiments, the system introduces a phenotype-driven variant prioritization step into a reporting and indexing pipeline that allows for manual searching and classification of variants relevant to a patient's medical and family history.

In some embodiments, data on genomic variants, such as VCF data 1201 from sources including but not limited to ClinVar, Human Gene Mutation Database (HGMD or a proprietary data source, comprising information including but not limited to SnpEff, Allele frequencies, variant content, and variant classifications is transferred, first through a Confidence Region Filter 1202 and a Panel Filter 1203, and into a Curation Database 1204 for curation. In some embodiments, expired and non-expired data regarding variants that have been labeled as “Pathogenic”, “Likely Pathogenic”, “VUS”, “Benign”, or “Likely Benign” are sent to Pre-Reporting 1209. Additionally, per some embodiments, all data is also sent through an Inheritance Filter 1205, which filters for benign disease inherence based variant data, and a Prevalence Filter 1206, which filters for benign disease prevalence based variant data.

In some embodiments, the data filtered by the Prevalence Filter 1206 is then sent to one or more Variant Database Filters 1207 which correlates the data that are available in databases including but not limited to ClinVar and HGMD, wherein data regarding variants labeled as “Benign”, as “Potentially Pathogenic” with a confidence level associated with “Manual Classification”, and as “Likely Pathogenic” with a confidence level associated with “Direct Reporting”, are sent to Pre-Reporting 1209. In some embodiments, unassigned data is sent from the Variant Database Filters 1207 to a Variant Classification 1208, which determines the classification of the variant based from one or more rules.

In some embodiments, a rule employs prevalence and the penetrance information to determine the classification of the variant, by calculating the disease prevalence derivative (dAF), and comparing it to the allele frequency (AF). In some embodiments, the AF and the dAF are calculated by recording the data associated with a single ethnic group within each of the one or more sources including but not limited to ExAC, 1000 Genomes, 10,000 Genomes, or an internal AF database. In one example, the AF and dAF relates to data from all Africans as reported by ExAC. In some embodiments, if the disease is classified as “autosomal dominant”, as “x-linked dominant”, and as “y-linked”, then

$$dAF = \frac{prevelance}{2 \times penetrance}$$

wherein the prevalence is the highest listed associated percentage value regarding the corresponding gene. In some embodiments, if the disease is classified, or additionally classified as “autosomal recessive”, and as “x-linked recessive”, then

$$dAF = \sqrt{\frac{prevelance}{penetrance}}$$

In some embodiments, if an incident number is registered from a source such as Orphanet, the incident number is used to determine the disease prevalence, per table 2 below, which is implemented in the calculation dAF, if that prevalence number is greater than the prevalence registered from other sources, or if no other registered prevalence data exists.

TABLE 2

| Incident Number/Population | Prevalence |
|---|---|
| >1/1,000 | 0.1% |
| 1-5/10,000 | 0.05% |
| 6-9/10,000 | 0.09% |
| 1-9/100,000 | 0.01% |
| 1-9/1,000,000 | 0.0009% |
| <1/1,000,000 | 0.0001% |

In some embodiments, for a report not categorized as Inherited Cancer, if a variant is linked to all diseases whose inheritance is labeled as “autosomal recessive”, “x-linked recessive”, and “y-linked”, and if the variant is linked to all diseases that have a highest recorded minor allele frequency (MAF) of less than 10%, 5%, 2%, 1%, or 0.1% in any ethnic subpopulation count, the system assigns the variant data the method “Disease non-Specific” and the classification “Benign”, and sends the variant data to QC Reporting 1211, via a Routing procedure 1210. In some embodiments, however, if the calculated AF of the variant is greater than its dAF, the system reassigns the variant the method of “Disease Specific.”

In some embodiments, for a report categorized as Inherited Cancer, if a variant is linked to all diseases whose inheritance is labeled as “autosomal recessive”, “x-linked recessive”, and “y-linked”, and if the variant is linked to all diseases that have a highest recorded minor allele frequency (MAF) of less than 10%, 5%, 2%, 1%, or 0.1% in any ethnic subpopulation count, the system assigns the variant the method “Disease non-Specific” and the classification “Benign”, and sends the data related to that variant to QC Reporting 1211, via a Routing procedure 1210. In some embodiments, however, if the calculated AF of the variant is greater than its dAF, the system reassigns the variant the method of “Disease Specific.”

In some embodiments, if a variant is associated with two or more diseases, for a report not categorized as Inherited Cancer, and if a variant is linked to all disease whose inheritance is labeled as “autosomal recessive”, “x-linked recessive”, and “y-linked”, and if the variant is linked to all diseases that have a highest recorded MAF of less than 10%, 5%, 2%, 1%, or 0.1% in any ethnic subpopulation count, the system assigns the variant the method “Disease non-Specific” and the classification “Benign”, and sends the data related to that variant to QC Reporting 1211, via a Routing procedure 1210. In some embodiments, however, if the calculated AF of the variant is greater than its dAF, the system reassigns the variant the method of “Disease Specific.”

In some embodiments, if a variant is associated with two or more diseases, for a report categorized as Inherited Cancer, if a variant is linked to all disease whose inheritance is labeled as “autosomal recessive”, “x-linked recessive” and “y-linked”, and if the variant is linked to all diseases that have a highest recorded minor allele frequency (MAF) of less than 10%, 5%, 2%, 1%, or 0.1% in any ethnic subpopulation count, the system assigns the variant the method “Disease non-Specific” and the classification “Benign”, and sends the data related to that variant to QC Reporting 1211, via a Routing procedure 1210. In some embodiments, however, if the calculated AF of the variant is greater than its dAF, the system reassigns the variant the method of “Disease Specific.”

In some embodiments, if a variant contains data associated with only one submitter from a list of trusted submitters and experts, and if the submission date is less than 12, 6, 3, 2, or 1 months from the date of the latest algorithm run, and if the submitter labeled the variant as “Pathogenic” with a clinical origin of “germline”, the system assigns the variant the method “ClinVar—Expert Panels” and a classification of “Pathogenic” and sends the data related to that variant to Reporting 1212, via a Routing procedure 1210.

In some embodiments, if a variant contains data associated with only one submitter from a list of trusted submitters and experts, and if the submission date is less than 12, 6, 3, 2, or 1 months from the date of the latest algorithm run, and if the submitter labeled the variant as “Likely Pathogenic” with a clinical origin of “germline”, the system assigns the variant the method “ClinVar—Expert Panels” and a classification of “Likely Pathogenic” and sends the data related to that variant to Reporting 1212, via a Routing procedure 1210.

In some embodiments, if a variant contains data associated with only one submitter from a list of trusted submitters and experts, and if the submission date is less than 12, 6, 3, 2, or 1 months from the date of the latest algorithm run, the system assigns the variant the method “ClinVar—Expert Panels—Non-Recent” and sends the data related to that variant to Manual Review 1220, via a Routing procedure 1210.

In some embodiments, if a variant contains data associated with only one submitter from a list of trusted submitters and experts, and if the submitter labeled the variant as “Likely Benign” or “Benign” with a clinical origin of “germline” the system assigns the variant the method “ClinVar—Expert Panels”.

In some embodiments, if a variant contains data associated with only one submitter from a list of trusted submitters and experts, and if the submitter labeled the variant as “Pathogenic” or “Likely pathogenic” with a clinical origin of “germline”, system assigns the variant the method “ClinVar—One or Low Conf Submission”, assigns the corresponding classification, and sends the data related to that variant to Manual Review 1218, via a Routing procedure 1210.

In some embodiments, if a variant contains data associated with two or more submitters from a list of trusted submitters and experts, and if the submitter did not label the variant as “Pathogenic” or “Likely Pathogenic” with a clinical origin of “germline” the system assigns the variant the method “ClinVar—Conflicting” and the classification “None” and sends the data related to that variant to Manual Review 1218, via a Routing procedure 1210.

In some embodiments, if a variant contains data associated with two or more submitters from a list of trusted submitters and experts, and if the submitter labeled the variant as one or a combination of “Benign” and “VUS”, the system assigns the variant the method “ClinVar—Conflicting” and the classification “VUS”, and sends the data related to that variant to QC Reporting 1211, via a Routing procedure 1210.

In some embodiments, if a variant contains data associated with two or more submitters from a list of trusted submitters and experts, and if the submitter labeled the variant as having a “germline” clinical origin and as “Pathogenic” or “Likely pathogenic”, and if the date of submission is less than 12, 6, 3, 2, or 1 months from the date of the last algorithm run, the system assigns the variant the method “ClinVar—Trusted Submitters” and a classification corresponding to the label most commonly assigned by the submitters, and sends the data related to that variant to Reporting 1212, via a Routing procedure 1210. In some embodiments, if there are equal amount of submissions labeled by the submitters as “Pathogenic” and “Likely Pathogenic”, the system assigns the variant the classification “Likely Pathogenic”.

In some embodiments, if a variant contains data associated with two or more submitters from a list of trusted submitters and experts, and if the submitter labeled the variant as having a “germline” clinical origin and as “Pathogenic” or “Likely Pathogenic”, and if the date of submission is more than 6 months from the date of the last algorithm run, the system assigns the variant the method “ClinVar—Trusted Submitters—Non Recent”, and a classification corresponding to the label most commonly assigned by the submitters, and sends the data related to that variant to Reporting 1212, via a Routing procedure 1210. In some embodiments, if there are equal amount of submissions labeled as “Pathogenic” and “Likely Pathogenic”, the system assigns the variant the classification of “Likely Pathogenic”.

In some embodiments, if a variant contains data associated with two or more submitters from a list of trusted submitters and experts, and if the submitter labeled the variant as having a “germline” clinical origin and as “Likely Benign” or “Benign”, the system assigns the variant the method “ClinVar—Trusted Submitters” and the classification “Benign” and sends the data related to that variant to QC Reporting 1211, via a Routing procedure 1210.

In some embodiments, if a variant contains a submission from a submitter that is not associated with a list of trusted submitters and experts, and if the submitter labeled the variant as having a “germline” clinical origin and as “Pathogenic” or “Likely Pathogenic”, the system assigns the variant the method “ClinVar—One or Low Conf Submission” and its corresponding classification and sends the data related to that variant to Manual Review 1218, via a Routing procedure 1210.

In some embodiments, if a variant is present in the HGMD database and is categorized as “DM high”, the system assigns the variant the method “HGMD—DM” and the classification “None” and sends the data related to that variant to Manual Review, 1218, via a Routing procedure 1210, with the counts of the variant's existing PMID IDs.

In some embodiments, if a variant has variant “snpeff_annotation” as nonsense, frameshift, splice sites +/−1 or 2 bp or initiation codon change, the variant is assigned the method “snpEff-null” and the classification “None” and the data related to that variant is sent to Manual Review 1218, via a Routing procedure 1210.

In some embodiments, variant data sent to Reporting 1212 is compiled, wherein data regarding variants forwarded to Clinician Workstations 1213 for review and signature, wherein data with a confidence rating for “Direct Reporting” related to variants classified as “Likely Pathogenic” and “Pathogenic” are saved as a completed Report 1214.

In some embodiments, variant data with a confidence level associated with “Manual Classification” 1218, is sent to Triage Interface 1215, and to Manual Variant Classification 1216, and then back to the Curation Database 1204 to be reprocessed and/or to Phenotype Variant Prioritization 1217 to prioritize the variant data via manual searches within databases including but not limited to private or public databases and ClinVar.

### User Feedback

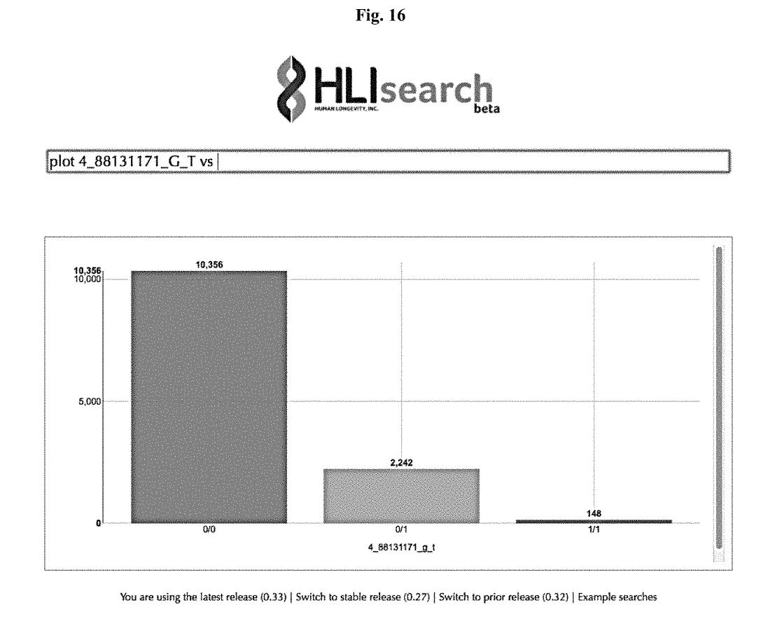

In some embodiments, the platforms, systems, media, and methods described herein include an interface allowing the user to provide user feedback on content and ranking of the results, or use of the same. In some embodiments, the user feedback is a “thumbs up” or “thumbs down.” In certain embodiments, the user feedback is used to tune the ranking formula. In some embodiments, user feedback is provided by an expert user. In some embodiments, user feedback provided by an expert user is weighted more heavily by the ranking formula. FIGS. 13A and 13B shows an example of how relevance learning using user input can be integrated into a user interface. Each result is associated with a selectable box 1302 that can selected by a user depending upon the relevance of that particular result. This feedback is used to improve the ranking formula. In certain embodiments, user input is a distinct criteria in the ranking, and more feedback increases the quality of the user input criteria. In certain embodiments, user input becomes a ranking criteria after more than 100, 1000, 10,000, 100,000, or 1 million distinct instances of user feedback.

### Data

In certain embodiments, the platforms, systems, media, and methods described herein searches a set of content or data. Examples of data include, but are not limited to: genome content; SNP data; genomic variants of an individual compared to a reference genome, such as a recent build of the human genome (currently build number 39), or a custom/de novo build; transcription factor binding sites; enhancer element binding sites; mRNA splice donor sites; mRNA splice acceptor sites; 5′ UTR; 3′ UTR; exon boundaries; intron boundaries; alternative mRNA splice variants; single-nucleotide polymorphisms; metabolome content; microbiome content; physiological data and measurements; own personal genome(s), including variants; ClinVar; HGMD; TR; OMIM Frequency; PCA; ancestry maps; privately stored data; a proprietary variant database (HLI database); PubMed; public scoring tools (e.g., Polyphen, CADD); face prediction; phenotypes; genotypes; gene ontology data (GO database); dbSNP; UCSC genome bowser; matching services genome-to-pathway data; drug to genome data; HLI validation data; HLI phenotype data; phenotype ontologies; gene expression data; protein expression data; protein phosphorylation data, gene methylation data; gene imprinting data; histone acetylation data; genome-wide association study data; HLI scoring tools (e.g., essentiality scores, tolerance scores; expression eQTL data; 3D topological structures; high confidence regions; singleton reliability; premium content; clinical trial searches and recruitment tools; HLI-expert interaction portal (joint curation) data; load your own VCF; share your genome; upload your EMR; privacy tools and services, clinical genetic services; Health nucleus data; and concierge services. In certain embodiments, the searchable data is metadata. In certain embodiments, the metadata comprises any of a patient/individual identifier, physiological data, clinical data, family medical history data, metabolome data, and microbiome data. In one aspect a layperson who has had their genome sequenced or their SNP profile or haplotype taken by a third-party provider, such as 23 and me or ancestry.com. can upload this third party data as a text file or other format and the genomic search engine can parse the data to extract SNPs. These SNPs can then be stored along with a person's profile and optionally phenotypic data and demographic data. This allows that person to determine variants in their own genome and search the genomic search engine for known or suspected disease associations.

### Digital Processing Device

In some embodiments, the platforms, systems, media, and methods described herein include a digital processing device, or use of the same. In further embodiments, the digital processing device includes one or more hardware central processing units (CPUs) or general purpose graphics processing units (GPGPUs) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, handheld computers, Internet appliances, mobile smartphones, tablet computers, and personal digital assistants. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-in

In some embodiments, the computer program includes a web browser plug-in (e.g., extension, etc.). In computing, a plug-in is one or more software components that add specific functionality to a larger software application. Makers of software applications support plug-ins to enable third-party developers to create abilities, which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, and personal digital assistants (PDAs). Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of user, query, token, and result information. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In other embodiments, a database is based on one or more local computer storage devices.

### Data Security

In some embodiments, the platforms, systems, media, and methods disclosed herein include one or methods to prevent unauthorized access. The security measures can, for example, secure a user's data. In some embodiments, data is encrypted. In some embodiments, access to the system requires multi-factor authentication. In some embodiments, access to the system requires two-step authentication. In some embodiments, two-step authentication requires a user to input an access code sent to a user's e-mail or cell phone in addition to a username and password. In some instances a user is locked out of an account after failing to input a proper username and password. The platforms, systems, media, and methods disclosed herein can, in some embodiments, also include a mechanism for protecting the anonymity of users' genomes and of their searches across any genomes.

### Uses

The platforms, systems, media, and methods disclosed herein have many uses. In some embodiments, the use is for research purposes. In some embodiments, the research purpose is to select targets for pharmaceutical development. In some embodiments, the research purpose is to select patients for clinical trials. In some embodiments, the research purpose is to segment patients for clinical trials. In some embodiments, the research purpose is to determine genomic response predictors for patients for clinical trials. In some embodiments, the research purpose is for a post hoc analysis of a clinical trial. In some embodiments, the use is for health care purposes. In some embodiments, the health care purpose is personalized medicine. In some embodiments, the health care purpose is to determine a disease prognosis. In some embodiments, the health care purpose is to determine a treatment course. In some embodiments, the health care purpose is to determine a relative likelihood of developing a certain disease. In some embodiments, the health care purpose is to determine whether a patient or individual should undergo one or more preventative measures. In some embodiments, the use is for personal discovery. In some embodiments, the use is to determine ancestry. In some embodiments, the use is to determine paternity. In some embodiments, the use is to determine Neanderthal ancestry. In some embodiments, the use is to determine Denisovan ancestry.

### Reports

It is envisioned that any of the results returned from the searches described herein can be formalized into a reporting procedure and delivered as printed or virtual reports either across the internet, through the mail, or in person by a healthcare professional.

### EXAMPLES

The following illustrative examples are representative of certain embodiments of the software applications, systems, and methods described herein and are not meant to be limiting in any way.

### Example 1—Individual User-Centric Searches

A user who has had their entire genome sequenced, and uploaded may use the search engine to discover DNA sequence variants that may be involved with certain ancestor groups, geographic regions, or Homo sapiens subspecies. For example, a user might search for their user ID and Neanderthal or Denisovan in order to discover their percent ancestry from each Homo sapiens subspecies. Users may have permission only for certain user IDs such as their own, or a family member that specifically grants access. A user may be able to discover sequence variants that differ between father and child, mother and child, siblings, grandparents and grandchildren, or cousins. For example, “ABC12345-ABC67890” returns all novel variants between a son (ABC12345) and a father (ABC67890).

### Example 2—Health Care Provider-Centric Searches

A health care provider treating a patient who has had their entire genome sequenced may use the search engine to discover DNA sequence variants that may be involved in disease risk. A health care provider may type in their patient's identification number and search for variants associated with disease. For example, the search string might be, “ABC12345 and known gene variants associated with diabetes,” which would return all variants that have been previously determined to play a role in diabetes by an orthogonal method such as GWAS. The provider may search for gene variants in genes that are known to play a role in diabetes, “ABC12345 and sequence variants in known genes associated with diabetes.” This search would return a list of sequence variants from the individual's sequence data that occur in a gene or near a gene that has previously shown involvement in diabetes from an orthogonal method such as mouse phenotyping. This may, for example, return a previously unknown sequence variant in the gene TCF7L2, which has a strong association with diabetes. Given this information, the provider might compare the frequency of mutations in genes associated with diabetes possessed by a certain patient to a population mean within the database, and decide on a course of preventive treatment. A health care provider may have permission to access information from patients. Additionally, the provider might select that variant and automatically query an association with that variant and fasting blood glucose from individual genomic/variant data that is loaded on a database. This can be achieved by selecting the variant and typing a short syntax such as for example, “vs diabetes” or “versus h1Ac” or “vs blood glucose”. In this way the provider can ascertain if there is a statistical association between this variant and high blood glucose amongst individuals that have been both phenotyped and genotyped. This gives the provider additional confidence that this gene variant may cause or is causing diabetes in the patient and allow for preventative measures or selection of a particular treatment course.

### Example 3—Researcher-Centric Searches

A researcher will use data searches and information from the genomic search engine to discover new therapeutic targets. A researcher interested in hypertension may type in a string such as, “sequence variants associated with hypertension with a p value less than 0.0000001.” The search will return a list of variants with p-values ranked from lowest to highest within the specified range. A given gene with a role in hypertension may have more than one sequence variant associated. Therefore, the researcher may group sequence variants by gene and use a variety of methods to sort the resulting genes (e.g., most sequence variants normalized for gene length, most sequence variants above a certain significance threshold, sequence variants in highly conserved regions, sequence variants represented within certain demographic groups). For example, the researcher may then search within the given results for highly significant p-values for genes that have functional annotation indicating a role in sodium transport. The researcher can then use this data to design experiments that test the involvement of a given sequence variant or gene in hypertension. These experiments could be at the cellular/molecular level or include constructing transgenic animals.

### Example 4—Custom Ranking Searches

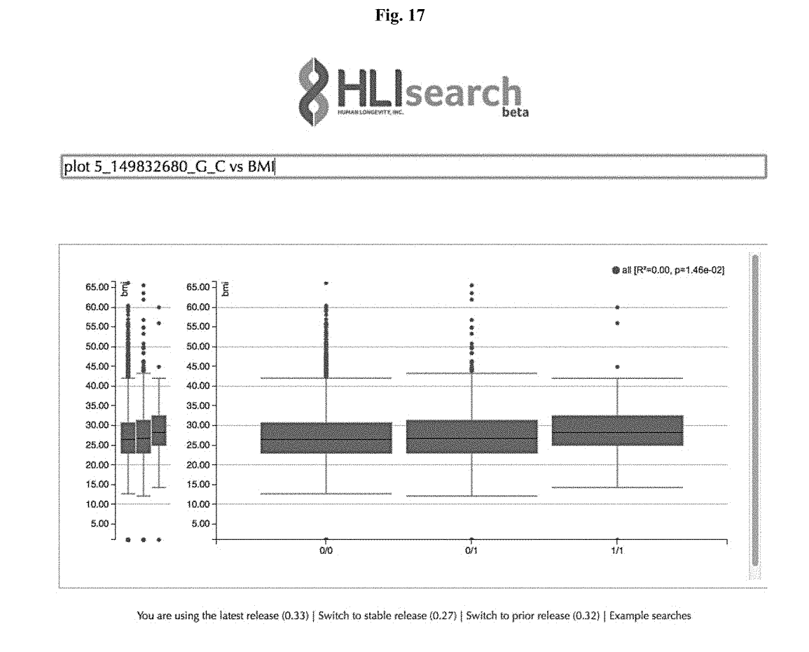

A client/hospital/company wishes to formalize a pattern of search that they consider appropriate for the routine use of querying. FIG. 14 shows the example output of this search on an individual's genome. For the diagnosis of a significant disorder, or for the identification of particularly damaging candidate variants, a top human geneticist advises to query genomes according to the following criteria, as illustrated in FIG. 14:
1. For a given individual genome file (“VCF”).
2. In a fixed set of genes (e.g., 220 top medically important and actionable genes in the screening for Mendelian disorders and carrier status).
3. Are there any variants 1402 that cause severe damage to a protein (so-call “loss of function” variants, LOFs)? Recognized types of LOFs are splice donor and acceptor site variants, premature protein stops (nonsense mutation), and frameshifts that cause the coding to fail to result in incorrect protein coding.
4. Are there missense (amino-acid changing) variants 1404?
5. Are there predicted consequences (“damaging”) 1406 as calculated using specific algorithms?
6. The query would contain the following terms that can be termed as “Medical”.

### Example 5—Individual Queries to Determine Medically Relevant Variants

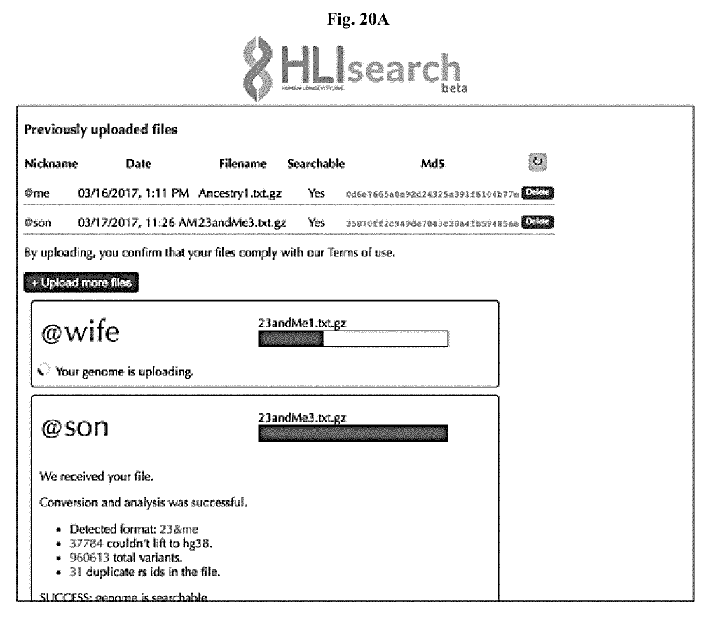

A health care provider/individual wishes to interrogate their genome/patient's genome for medically relevant variants. FIG. 15A shows the example output of this search on an individual's genome. The individual/healthcare provider types a query such as “@me” or @[patient number]” into the search bar 1501. The search returns basic statistics 1502 such as, for example, the amount of variants falling within a specified criteria, the number that are heterozygous or homozygous. The search also returns specific ranked results 1503a-1503f. In FIG. 15B each result can contain additional information 1504 such as allele frequency (in this case less than 0.1%) among variants queried and the type of mutation (such as missense, nonsense, frame shift) and/or genomic functional element (intron, exon, promoter, 5′ UTR, or 3′ UTR). The user can click on a link 1505 that shows a graphical representation of the individuals in a given population (including all individuals that have uploaded genomic data). Also displayed is gene name 1506 and RS number 1507 if available the renumber. This output is exemplified in FIG. 16. Additionally, information is provided on exact genomic coordinates, exact substitution or indel and the user can click on a link 1509 that allows visualization of the gene in the context of the genome, this could take the user to an external genome visualizer such as UCSC genome browser. The user can also click on a hyperlink 1510 with more in-depth information on the gene variant. In certain embodiments, this connects the user to an external database such as various NCBI databases comprising information on genes. Additionally, a doctor or individual can query the variant to see if there is association with a phenotypic trait in individuals who have had their variants recorded in genomic database as exemplified in FIG. 17. The source of the individual's genomic data can be a direct upload to the database from a sequencing facility or can be uploaded manually through a portal as shown in FIG. 18.

### Example 6—Phenotype/Genotype Plotting

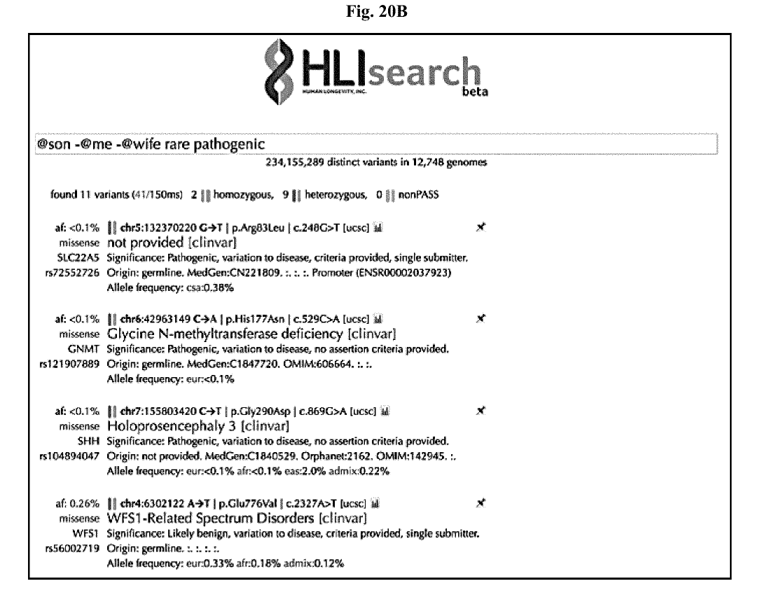

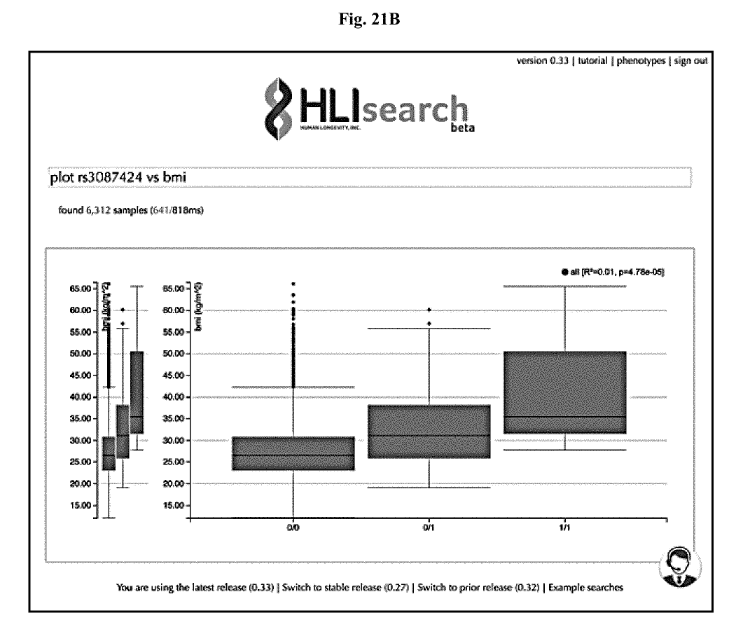

In one exemplary embodiment the search capabilities allow the user to visually explore the phenotypes and genotypes across an arbitrary cohort of individuals. Plots can be triggered from the query box, and provide a visual overview of what data is available. The search can plot one or more variables at the same time, and automatically select the most appropriate plot type for the variables: e.g. a histogram (FIG. 19A), a scatter plot (FIG. 19B) or a box-and-whisker plot (FIG. 21B). HLI search understands both numeric and categorical variables, and can plot both genotype variables (such as copy-number variation or presence of a particular mutation) and phenotype variables (such as gender or blood sugar lever). Phenotype and genotype variables can also be used to color sub-cohorts in the plot, to show for example that males tend to be taller than females in our dataset (FIG. 19A). The plots can also be restricted to arbitrary cohorts. Phenotype and genotype values can be combined in the same plot, e.g., to show how presence of a particular mutation is correlated with elevated body-mass index (BMI) measurements as shown in FIG. 21B. HLI search also allows a combination of two or more variables to be plotted against a single variable (for example, to visualize that BMI better correlates with a combination of height and weight than with either of them individually).

### Example 7—Personal Genome Upload

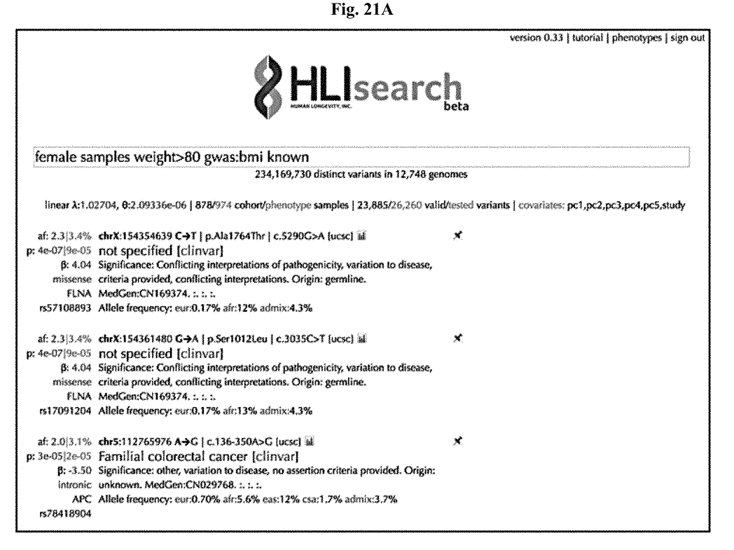

The Search allows the user to upload arbitrary genomes from 3rd party providers. The genomes can be in the form of SNP arrays (such as 23andMe, Ancestry.com, or Illumina OMNI chips), or in the form of exome sequences, or in the form of whole-genome sequences. HLI Search automatically detects the format of the uploaded genome, decompresses it if necessary, and converts to the correct reference. The user can upload one or more genomes, e.g., for a family. Once uploaded, the genomes can be analyzed against the backdrop of HLI knowledge in the same way as if they were sequenced by HLI. FIGS. 20A and 20B shows an example of a user uploading SNP arrays for their family (FIG. 20A) and performing trio analysis for de-novo pathogenic variants in the child (FIG. 20B). Uploaded genomes are anonymized, and kept private to the user who uploaded them.

### Example 8—Real-Time GWAS

The Search provides a capability for performing Genome-Wide Associations Studies (GWAS) in real-time from the query box. The user can specify the target phenotype, the covariates, the thresholds, and a number of other parameters. The user can also precisely specify the cohort over which GWAS will be performed. An example is provided in FIG. 21A, where the user is looking for variants associated with Body-Mass Index (BMI) in a sub-population of overweight females. Once the plausible variants are identified, their effect on BMI can be confirmed visually by plotting BMI vs. presence or absence of the variant as in FIG. 21B.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A computer-implemented method of providing a genomic search engine comprising:
a) storing a plurality of indices in a computer storage, the indices comprising tokenized genomic data;
b) providing an indexing pipeline, the indexing pipeline ingesting genomic data and annotation associated with the genomic data, tokenizing the data while preserving gene names and gene variant names, and updating the indices with the tokenized data;
c) presenting a user interface allowing a user to enter a user query; and
d) providing a query engine, the query engine accepting the user query, selecting one or more relevant indices, and applying a ranking formula to the selected indices to return ranked results.

2. The method of claim 1, further comprising presenting a user interface allowing the user to provide user feedback on content and ranking of the results.

3. The method of claim 1, further comprising providing a relevance-learning engine, the relevance-learning engine accepting the user feedback and tuning the ranking formula based on the feedback.

4. The method of claim 1, wherein the genomic data comprises whole genome sequence data, whole exome sequence data, SNP sequence data, or genomic variant data.

5. The method of claim 1, further comprising presenting a user interface allowing the user to upload genomic or SNP sequence data into the indexing pipeline.

6. The method of claim 1, wherein the user query comprises a genomic sequence file, a variant call format file, a gene, a gene variant or mutation, an individual identifier, a drug, a phenotype, or a combination thereof.

7. The method of claim 1, wherein the interface allowing a user to enter a user query is a universal interface accepting entry of any of: a genomic sequence file, a gene, a gene variant or mutation, an individual identifier, a drug, a phenotype, or a combination thereof.

8. The method of claim 1, wherein the user query comprises a gene name and the ranked results comprise variants associated with the gene.

9. The method of claim 1, wherein the user query comprises an individual identifier and the ranked results comprise gene variants in the genome of the individual.

10. The method of claim 1, wherein the user query comprises an individual identifier and a phenotype and the ranked results comprise gene variants in the genome of the individual associated with the phenotype.

11. The method of claim 1, wherein the user query comprises a gene variant and the ranked results comprise patient identifiers for patients who have the variant in their genome.

12. The method of claim 1, wherein the user query comprises a phenotype and the ranked results comprise gene variants that are associated with the phenotype.

13. The method of claim 1, wherein the query comprises natural language terms and one or more special operators.

14. The method of claim 1, wherein the user query comprises a first individual identifier and at least a second individual identifier, wherein each of the individual identifiers is separated by an operator and the ranked results comprise gene variants that are present in the genome of the first individual and not in the genome of the second individual.

15. The method of claim 1, wherein the ranking formula comprises using the relative frequency to rank results obtained from a user query.

16. The method of claim 1, wherein the results are ranked without filtering.

17. The method of claim 1, wherein the relevance-learning engine augments the user feedback with information from external sources.

18. The method of claim 1, further comprising pre joining two or more of the plurality of indices.

19. A computer-implemented system comprising: a computer storage, a digital processing device comprising: at least one processor, an operating system configured to perform executable instructions, a memory, and a computer program including instructions executable by the digital processing device to create a genomic search engine application comprising:
a) a plurality of indices, recorded in the computer storage, the indices comprising tokenized genomic data;
b) a software module providing an indexing pipeline, the indexing pipeline ingesting genomic data and annotation associated with the genomic data, tokenizing the data while preserving gene names and gene variant names, and updating the indices with the tokenized data;
c) a software module presenting a user interface allowing a user to enter a user query; and
d) a software module providing a query engine, the query engine accepting the user query, selecting one or more relevant indices, and applying a ranking formula to the selected indices to return ranked results.

20. A non-transitory computer-readable storage media encoded with a computer program including instructions executable by a processor to create a genomic search engine application comprising:
a) a plurality of indices, recorded in the computer storage, the indices comprising tokenized genomic data;
b) a software module providing an indexing pipeline, the indexing pipeline ingesting genomic data and annotation associated with the genomic data, tokenizing the data while preserving gene names and gene variant names, and updating the indices with the tokenized data;
c) a software module presenting a user interface allowing a user to enter a user query; and
d) a software module providing a query engine, the query engine accepting the user query, selecting one or more relevant indices, and applying a ranking formula to the selected indices to return ranked results.
